(19) United States
(12) Patent Application Publication
(10) Pub. No.: US 2025/0181391 A1
(43) Pub. Date: Jun. 5, 2025

(54) CONTROL METHOD, PROCESSOR AND COMPUTER SYSTEM FOR SYSTEM MANAGEMENT MODE

(71) Applicant: Shanghai Zhaoxin Semiconductor Co., Ltd., Shanghai (CN)

(72) Inventors: Weilin WANG, Beijing (CN); Yankui NIU, Beijing (CN); Jinglong LIU, Beijing (CN); Jiangbo WANG, Beijing (CN); Yingbing GUAN, Shanghai (CN); Long CHENG, Shanghai (CN)

(21) Appl. No.: 18/779,538

(22) Filed: Jul. 22, 2024

(30) Foreign Application Priority Data
Nov. 30, 2023 (CN) 202311632912.6

(51) Int. Cl. G06F 9/50; G06F 9/46

(52) U.S. Cl. CPC G06F 9/5016; G06F 9/468

(57) ABSTRACT

The present application relates to the technical field of system management mode (SMM), and in particular it relates to a control method, a processor, and a computer system for system management mode. The method is applied to a processor. The processor includes at least one logical core. The method performs an initialization setting before each logical core enters system management mode. The initialization setting includes: allocating system management random access memory (SMRAM) required in the SMM to each logical core; and storing addresses related to the SMRAM of each logical core into at least one model-specific register MSR. There is no need to set SMRAM for each logical core serially. This shortens the time spent on initialization in the SMM and improves the execution efficiency of initialization.

### CROSS REFERENCE TO RELATED APPLICATIONS

This application claims priority of China Patent Application No. CN 202311632912.6, filed on Nov. 30, 2023, the entirety of which is incorporated by reference herein.

### BACKGROUND OF THE INVENTION

### Field of the Invention

The present disclosure relates to the technical field of system management mode, and in particular, to a control method, processor and computer system for system management mode.

### Description of the Related Art

System Management Mode (SMM) is a special operating mode of a processor, which is usually configured to implement system-level functions, such as system monitoring, power management, error handling or private functions defined by the original equipment manufacturer (OEM). How to implement the initialization of the system management mode efficiently is one of the problems to be solved by those skilled in the art.

### BRIEF SUMMARY OF THE INVENTION

In view of this, the present disclosure proposes a control method, a processor, and a computer system for system management mode.

According to an aspect of the present disclosure, a control method for a system management mode is provided and applied to a processor. The processor includes at least one logical core. The method includes performing an initialization setting before the each logical core enters the system management mode (SMM). The initialization setting includes the steps of allocating system management random access memory (SMRAM) required in the SMM for the each logical core; and storing address(es) associated with the SMRAM of the each logical core into at least one model specific register (MSR).

According to another aspect of the present disclosure, a processor is provided. The processor comprises at least one logical core and at least one model specific register MSR. The processor is configured to perform initialization setting before the each logical core enters a SMM. The initialization setting includes the steps of allocating SMRAM required in the SMM for the each logical core; and storing address(es) associated with the SMRAM of the each logical core into corresponding MSR(s).

According to another aspect of the present disclosure, a computer system is provided, including a processor, comprising at least one logical core and at least one MSR; and memory. The processor is configured to perform initialization setting before the each logical core enters a SMM, and the initialization setting includes the steps of allocating SMRAM required in the SMM for the each logical core, wherein the SMRAM is located in the memory; and storing address(es) associated with the SMRAM of the each logical core into corresponding MSR(s).

Through the control method, processor and computer system for SMM provided in the embodiments of the present disclosure, there is no need to set SMRAM for each logical core serially. This shortens the time spent on initialization and improves the execution efficiency of the initialization of the SMM.

### BRIEF DESCRIPTION OF THE DRAWINGS

The description and the accompanying drawings, which are included in and constitute a part of the specification, collectively illustrate exemplary embodiments, features, and aspects of the disclosure to explain the principles of the disclosure.

FIG. 1 shows a block diagram of a processor applying the control method for SMM according to an embodiment of the present disclosure.

FIG. 2 shows a flowchart for initialization setting in the control method for SMM according to an embodiment of the present disclosure.

FIG. 3 shows a schematic diagram of the SMRAM in the control method for the SMM according to an embodiment of the present disclosure.

FIG. 4 shows a flowchart of response execution steps in a control method for SMM according to an embodiment of the present disclosure.

FIG. 5 shows a flowchart for initialization setting in a control method for SMM according to an embodiment of the present disclosure.

FIG. 6 shows a flowchart of response execution steps in a control method for SMM according to an embodiment of the present disclosure.

FIG. 7 illustrates a block diagram of a processor applied in Example 1 according to an embodiment of the present disclosure.

FIG. 8 shows a flow chart for initialization setting in Example 1 according to an embodiment of the present disclosure

FIG. 9 shows a schematic diagram of the first memory space and the SMRAM in Example 1 according to an embodiment of the present disclosure.

FIG. 10 shows a schematic diagram of a configuration information structure according to an embodiment of the present disclosure.

FIG. 11 shows a flowchart of response execution steps in Example 1 according to an embodiment of the present disclosure.

FIG. 12 shows a block diagram of a processor applied in Example 2 according to an embodiment of the present disclosure.

FIG. 13 shows a flowchart for initialization setting in Example 2 according to an embodiment of the present disclosure.

FIG. 14 shows a flowchart of response execution steps in Example 2 according to an embodiment of the present disclosure.

FIG. 15 shows a flowchart for the initialization setting in Example 3 according to an embodiment of the present disclosure.

FIG. 16 shows a schematic diagram of the first memory space and the SMRAM in Example 3 according to an embodiment of the present disclosure.

FIG. 17 shows a block diagram of a processor applied in Example 4 according to an embodiment of the present disclosure.

FIG. 18 shows a flowchart for initialization setting in Example 4 according to an embodiment of the present disclosure.

FIG. 19-FIG. 21 show schematic diagrams of the first memory space and the SMRAM in Example 4 according to an embodiment of the present disclosure.

FIG. 22 shows a schematic diagram of a configuration information structure according to an embodiment of the present disclosure.

FIG. 23 shows a flow chart for initialization setting in Example 4 according to an embodiment of the present disclosure.

FIG. 24 shows a flowchart of response execution steps in Example 4 according to an embodiment of the present disclosure.

FIG. 25 shows a block diagram of a processor applied in Example 6 according to an embodiment of the present disclosure.

FIG. 26 shows a flow chart for initialization setting in Example 6 according to an embodiment of the present disclosure.

FIG. 27-FIG. 28 illustrate a schematic diagram of the SMRAM in Example 6 according to an embodiment of the present disclosure.

FIG. 29 shows a flowchart of response execution steps in Example 6 according to an embodiment of the present disclosure.

FIG. 30 shows a block diagram of a computer system according to an embodiment of the present disclosure.

### DETAILED DESCRIPTION OF THE INVENTION

Various exemplary embodiments, features, and aspects of the present disclosure will be described in detail below with reference to the accompanying drawings. The same reference numbers in the drawings represent elements with functions that are the same or similar. Although various aspects of the embodiments are illustrated in the drawings, the drawings are not necessarily drawn to scale unless otherwise indicated.

The word “exemplary” as used herein means “serving as an example, embodiment, or illustrative.” Any embodiment described herein as “exemplary” is not necessarily to be construed as superior to or better than other embodiments.

In addition, in order to explain the present disclosure better, numerous specific details are given in the following detailed description. It should be understood by those skilled in the art that the present disclosure may be implemented without certain specific details. In some instances, methods, means, components and circuits that are well known to those skilled in the art are not described in detail in order to emphasize the subject matter of the disclosure.

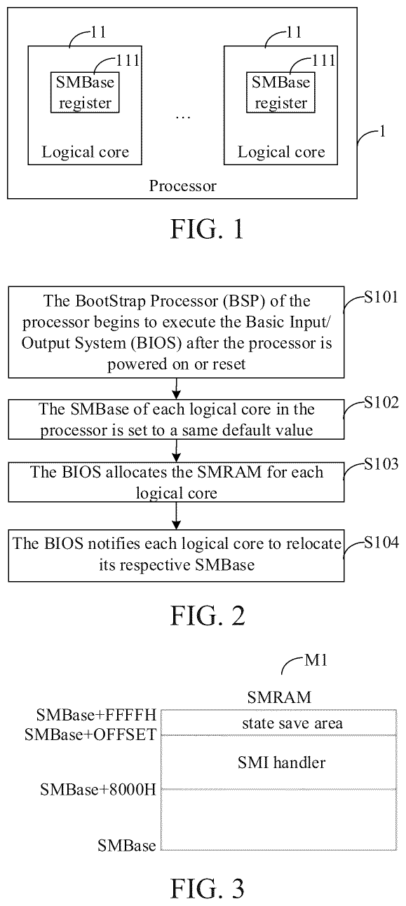

The present disclosure provides a control method for system management mode. FIG. 1 shows a block diagram of a processor applying the control method for system management mode (SMM) according to an embodiment of the present disclosure. This method is applied in the processor 1 shown in FIG. 1. The processor 1 may include one or more logical cores 11. Each logical core 11 in the processor 1 is configured with a system management memory base address (SMBase) register 111 in the logical core 11. The SMBase register 111 is configured to store the base address of the corresponding system management random access memory (SMRAM) M1 as shown in FIG. 3 of the logical core 11.

FIG. 2 shows a flow chart for initialization setting in the control method for system management mode according to an embodiment of the present disclosure. As shown in FIG. 2, the initialization setting in the control method for the system management mode may include steps S101 to S104.

In step S101, after the processor is powered on or reset, the BootStrap Processor (BSP) of the processor begins to execute the Basic Input/Output System (BIOS). In an embodiment, the processor 1 may include at least one core. Each core may include at least one logical core 11. A logical core 11 in the processor 1 may be configured as BSP.

In step S102, the SMBase of each logical core in the processor is set to the same default value. For example, the SMBase of each logical core is set to the same default value of 30000H (hexadecimal number, the same below) but the disclosure is not limit thereto.

FIG. 3 shows a schematic diagram of the SMRAM in the control method for the system management mode according to an embodiment of the present disclosure. As shown in FIG. 3, since the SMRAMs of all logical cores are located in the same memory (e.g., the system memory of the computer system, or an independent memory space independent of the system memory), if the SMBase of each logical core is set to the same default value, the state save area of each logical core 11 overlaps (i.e., the state save area of all logical cores 11 occupy the same range of memory address). If two or more logical cores 11 enter the system management mode at the same time, the state information (also called context, including values of various general-purpose registers (e.g., RAX, RBX, RCX, RDX, etc.) and so on) saved by the previous logical core 11 in the state save area will be overwritten by the logical core 11 that enters SMM later. This causes the previous logical core 11 to be unable to exit SMM normally. Therefore, in order to ensure that two or more logical cores 11 can exit SMM normally after entering SMM at the same time, the BIOS must relocate the SMBase of each logical core 11 to an appropriate location. Each logical core 11 can relocate its SMBase only after entering SMM by modifying the value of the SMBase register 111. In addition, due to the reasons mentioned above, each logical core 11 can only sequentially (i.e., serially) enter the SMM to relocate its SMBase (i.e., perform the following steps S103 and S104).

In step S103, the BIOS allocates the SMRAM M1 as shown in FIG. 3 for each logical core 11. The base addresses of the SMRAM M1 of different logical cores 11 are different.

As shown in FIG. 3, the SMRAM M1 of each logical core 11 is configured as a fixed structure, of which the memory space between SMBase˜SMBase+8000H is free. In the SMRAM M1, the memory space from SMBase+8000H is configured to store the system management interrupt handler (SMI handler). The state save area is located in the memory space from SMBase+OFFSET to SMBase+FFFFH, and is configured to save the state information of the logical core 11 before the logical core 11 enters SMM. Wherein, OFFSET is a hexadecimal number greater than 8000H and less than FFFFH. In an embodiment, OFFSET is FE00H. In another embodiment, OFFSET is FC00H.

In step S104, the BIOS notifies each logical core 11 to relocate its respective SMBase. Specifically, the BIOS writes the start address of the SMRAM M1 allocated in step S103 into the SMBase register after sending system management interrupts (SMIs) in turn to each logical core 11 to make each logical core enter SMM. Wherein, the BIOS notifies the next logical core 11 to relocate the SMBase after a logical core 11 completes the relocation of the SMBase. That is, this process is serial and inefficient.

In this way, through steps S101 to S104, the BSP realizes relocating the SMBase for each logical core 11 through the BIOS. This ensures that each subsequent logical core 11 can respond to the SMI at the same time. However, since each logical core 11 needs to enter the SMM serially for relocating the SMRAM, the initialization setting process of the SMM is inefficient.

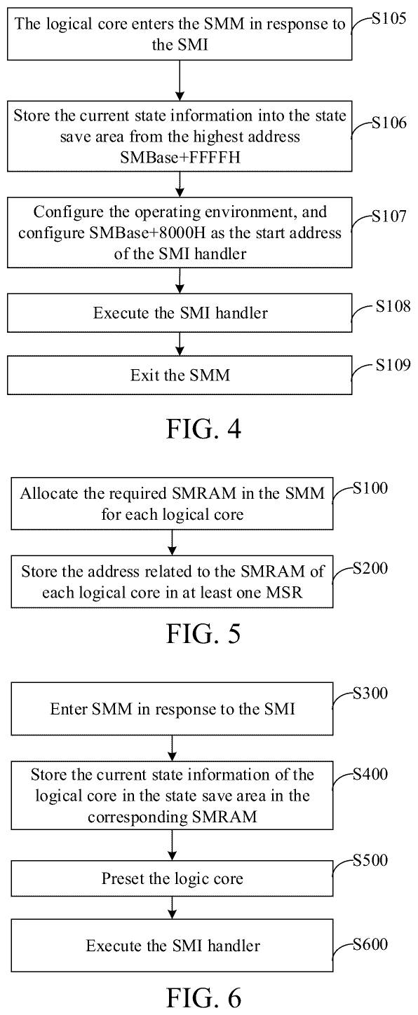

FIG. 4 shows a flowchart of response execution steps in the control method for SMM according to an embodiment of the present disclosure. As shown in FIG. 4, the response execution steps (i.e., the steps for processing the SMI) in the control method for the SMM may include steps S105 to S109. The following takes a logical core as an example to illustrate how the logical core 11 handles SMI in FIG. 4.

In step S105, the logical core enters the SMM in response to the SMI.

In step S106, the logical core determines the address range of the corresponding state save area (SMBase+OFFSET˜SMBase+FFFFH) by the SMBase. Then, the logical core stores its current state information into the corresponding state save area from the highest address (e.g., SMBase+FFFFH) (i.e., stores its current state information from the highest address to the lower address).

In step S107, the logical core loads the required information for configuring the operating environment to configure the operating environment. Also, the logical core determines SMBase+8000H as the entrance to the SMI handler (i.e., SMBase+8000H is the start address of the memory space for the SMI handler). In some embodiments, configuring the operating environment may indicate configuring the values of corresponding registers as shown in Table 1 below. Wherein, the operating mode of the logical core can be set to real mode by setting the PE, EM, TS and PG bits of the CR0 register to 0.

TABLE 1
Settings for register configurations

| register | contents |
|---|---|
| general purpose | undefined (i.e., the value stored in the general |
| registers | purpose register is undetermined) |
| EFLAGS | 00000002H |
| EIP | 00008000H |
| CS selector | Right shift 4 bits of SMBase (3000H by default) |
| CS base | SMBase (default: 30000H) |
| DS, ES, FS, GS, SS | 0000H |
| Selectors | |
| DS, ES, FS, GS, SS | 000000000H |
| base | |
| DS, ES, FS, GS, SS | 0FFFFFFFFH |
| Limits | |
| CR0 | PE, EM, TS and PG is set to 0; No modification |
| | for others. |
| CR4 | Clear to 0. |
| CR6 | Undefined (i.e., the value stored in CR6 is |
| | undetermined) |
| CR7 | 00000400H |

In step S108, the logical core starts executing the SMI handler. In the SMI handler, the logical core first switch its operating mode from real mode to the target operating mode (e.g., 64 bit mode), and execute the remaining code of the SMI handler in the target operating mode (e.g., 64 bit mode). Since the switch of operating mode is necessary, the execution efficiency of the SMI handler is reduced. In addition, as shown in Table 1, since the values of some registers are undefined (e.g., the values of general-purpose registers), the logical core needs to load the required values into these registers before executing the remaining code of the SMI handler. This also reduces the execution efficiency of the SMI handler.

In step S109, the logical core executes the RSM instruction at the end of the SMI handler to exit the SMM. Specifically, the logical core restores the state information saved in the state save area (e.g., writes the values of each register saved in the state save area back to each register) in response to the RSM instruction, and exits the SMM. Then, the logical core continues to execute the process that it was executing before receiving the SMI.

It should be noted that the above steps S105 to S107 are implemented by the hardware of the logical core. The above steps S108 to S109 are implemented by executing the SMI handler by the logical core.

As set forth above, the methods shown in FIG. 1 to 4 can achieve normal execution of SMI, but there are problems as follow:

### Problem 1:

Since the SMBase of each logical core is set to the same default value in the initial status, in order to ensure that each logical core can respond to the SMI at the same time, it is necessary to relocate the SMBase for each logical core by executing steps S101 to S104. However, it is very time-consuming to relocate the SMBase for each logical core since it only allow each logical core to execute serially. Also, the setting of the SMRAM M1 shown in FIG. 3 only defines the usage of the top (i.e., the address less than SMBase+FFFFH) and middle (i.e., the address higher than SMBase+8000H) of the SMRAM, and do not define the usage of the bottom of the SMRAM (i.e., below SMBase+8000H). This may easily causes memory fragmentation (e.g., the bottom of SMRAM may not be used), and makes the code for memory management in SMM more complex.

### Problem 2:

After each logical core enters SMM, it will be set to the real mode by the hardware of the logical core. However, because some codes in the SMI handler can only be executed in the target operating mode (e.g., 64 bit mode), the operating mode must be switched to the target operating mode (e.g., 64 bit mode) first in the SMI handler. As a result, the logical core must perform a fixed operation of switching from the real mode to the target operating mode (e.g., 64 bit mode) every time it executes the SMI handler. This reduces the execution efficiency of the SMI handler.

### Problem 3:

As shown in Table 1, after the logical core enters SMM, the values of some registers (e.g., general purpose registers) are undefined (i.e., uncertain). Each time the logical core executes the SMI handler, it need to load the required values into these registers first. This also reduces the execution efficiency of the SMI handler.

In order to solve the above problems, embodiments of the present disclosure also provide a control method for the system management mode. FIG. 5 shows a flow chart of initialization setting in the control method for system management mode according to an embodiment of the present disclosure. FIG. 6 shows a flowchart of response execution steps in the control method for system management mode according to an embodiment of the present disclosure. The method may be applied to the processor with at least one logical core. In some embodiments, the processor may include at least one core, each of which includes at least one logical core.

As shown in FIG. 5, initializing setting in this method may include step S100 and step S200.

In step S100, SMRAM required in the SMM is allocated for each logical core.

In step S200, the addresses related to the SMRAM of each logical core are stored in at least one model specific register (MSR) (e.g., the first MSR, the second MSR, the third MSR, the third MSR, the fourth MSR, the fifth MSR as described below). In an embodiment, the core configuration information is preset in the SMRAM, and the start address of the memory space storing the core configuration information can be determined through at least one MSR. Each logical core does not need to enter the SMM when reading and writing the MSR, so each logical core can execute step S200 in parallel, which is more efficient.

In this way, through the above initialization setting, SMRAM can be set for each logical core in parallel. This shortens the time spent on initialization and improves the execution efficiency of initialization.

As shown in FIG. 6, in an embodiment, the response execution steps in the method may include steps S300 to S600.

In step S300, the logical core enters SMM in response to the SMI. Specifically, the logical core generates an SMI acknowledge transaction after receiving the SMI to indicate entering SMM. In another embodiment, the logical core asserts the SMIACT #pin (SMI acknowledge pin) after receiving the SMI to indicate entering SMM.

In step S400, the current state information of the logical core is stored in the state save area in the corresponding SMRAM. Specifically, the logical core determines the address of the state save area in the SMRAM based on the address stored in at least one MSR, and then stores the current state information of the logical core into the state save area in the corresponding SMRAM. For example, the logical core can write the value of the architectural register into the state save area in the SMRAM, and so on. Wherein, the architectural registers include general-purpose registers (e.g., RAX, RBX, RCX, RDX, etc.), segment registers (e.g., CS, DS, SS, etc.), and so on.

In step S500, the logical core is preset. In an embodiment, the hardware of the logical core (e.g. the interrupt processing unit) first read the core configuration information from the corresponding area in the SMRAM according to the address stored in at least one MSR, and then preset the logical core according to the core configuration information. For example, the operating mode of the logical core can be set to the target operating mode (e.g., 64 bit mode; the specific setting will be described in detail later) according to the core configuration information. In another embodiment, the hardware of the logical core (e.g., the interrupt processing unit) directly preset the core configuration information. The hardware of the logical core (e.g., the interrupt processing unit) directly presets the logical core according to the default core configuration information.

In step S600, the SMI handler is executed.

It should be noted that in steps S400 to S600, the address of the state save area, the address of the core configuration information and the address of the SMI handler are all based on the address stored in the corresponding at least one MSR.

In addition, the above steps S300 to S500 are implemented by the hardware of the logical core in the processor. The above step S600 is implemented by executing the SMI handler by the logical core.

In this way, through the above response execution steps, the address of the state save area, the address of the memory space for the core configuration information and the address of the SMI handler can be determined directly according to at least one MSR. The mode-setting information contained in the core configuration information allows each logical core to directly enter the target operating mode through hardware setting each time it enters the SMM. The logical core does not need to perform the fixed operation of mode switching when executing the SMI handler. This can improve the execution efficiency of the SMI handler. In addition, the core configuration information can be customized according to actual needs (e.g., customized setting for general-purpose registers) to reduce the setting operations during the execution of the SMI handler to further improve the execution efficiency of the SMI handler. For example, the identification of each logical core can be written into general-purpose registers (e.g., RAX) according to the core configuration information. In this way, the SMI handler can directly read the identification of the corresponding logical core from the general-purpose register without executing instructions (e.g., CPUID instructions). Accordingly, the execution efficiency of the SMI handler is improved.

In order to implement the method shown in abovementioned FIG. 5 and FIG. 6, each step of the method and the processor that executes the method can be set according to actual needs. This disclosure uses several schematic examples below to illustrate possible implementations of the methods shown in FIG. 5 and FIG. 6.

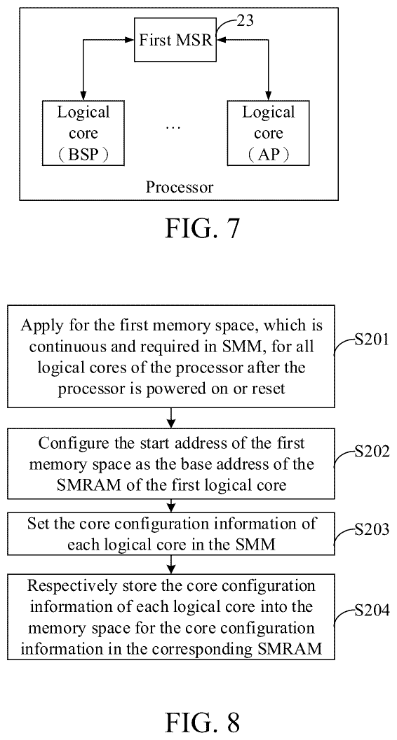

Example 1 (described below with reference to FIG. 7-FIG. 11):

FIG. 7 illustrates a block diagram of the processor applied in Example 1 according to an embodiment of the present disclosure. As shown in FIG. 7, this method can be applied to the processor as shown in FIG. 7, which includes multiple logical cores and a first MSR 23. The logical core includes a first logical core and at least one second logical core. The first logical core may be the BSP, and the second logical core may be the application processor (AP). For simplicity, FIG. 7 only schematically shows that the processor includes two logical cores, BSP and AP respectively. In an embodiment, the first MSR 23 is configured in an uncore (e.g., an interconnect structure between cores) of the processor.

FIG. 8 shows a flowchart for initialization setting in Example 1 according to an embodiment of the present disclosure, which can be applied to the processor shown in FIG. 7. As shown in FIG. 8, the initialization setting in this method may include steps S201 to S204.

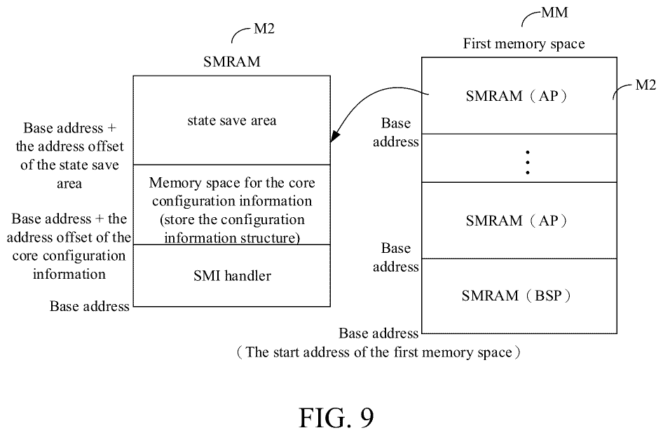

In step S201, after the processor is powered on or reset, the first logical core of the processor executes the BIOS to apply for the first memory space MM as shown in FIG. 9, which is continuous and required in system management mode, for all logical cores. The first memory space MM is a continuous memory space, and is configured as the SMRAM M2 of each logical core of the processor. Wherein, the first memory space MM (and the first memory space described below) may be allocated from the system memory that can only be accessed in the SMM or the memory independent of the system memory.

FIG. 9 shows a schematic diagram of the first memory space and the SMRAM in Example 1 according to an embodiment of the present disclosure. As shown in FIG. 9, in the initialization setting, each logical core may be allocated a SMRAM M2 as shown in FIG. 9, and the SMRAM M2 of each logical core has the same size (e.g., 64K bytes) by default. During the process of requesting the first memory space MM, the product of the default size of the SMRAM and the number of logical cores can be configured as the size of the first memory space MM to be allocated.

In step S202, the first logical core executes the BIOS to configure the start address of the first memory space MM as the base address of the SMRAM M2 of the first logical core, and stores the base address of the corresponding SMRAM M2 of the first logical core into the first MSR 23. The first logical core can write/read (by using the instruction WRMSR/RDMSR) the base address of the corresponding SMRAM M2 into/from the first MSR 23. The second logical core can read (by using the instruction RDMSR) the base address of the corresponding SMRAM M2 from the first MSR 23. Wherein, the first MSR may be a 64-bit MSR.

In this embodiment, as shown in FIG. 9, in the corresponding SMRAM M2 of each logical core, the base address of the SMRAM M2 allocated to each logical core is the address of the SMI handler (i.e., the base address of the SMRAM M2 is the start address of the SMI handler). The memory space corresponding to the preset address offset of the core configuration information is a memory space for storing the core configuration information of the logical core. The memory space corresponding to the preset address offset of the state save area is the state save area of the logical core. Wherein, the base address of the SMRAM M2 of the first logical core is the base address stored in the first MSR as mentioned above. The base address of the SMRAM M2 of the second logical core is determined by the association between the base address of the corresponding SMRAM M2 of the first logical core and the base address of the corresponding SMRAM M2 of the second logical core. Different second logical cores and first logical cores have different base address associations.

In some embodiments, the address association may be determined by the size of the SMRAM M2 of each logical core and the identification of each logical core (e.g., the Advanced Programmable Interrupt Controller ID (APIC_ID) of the logical core can be used as the identification of the logical core). Assuming that the corresponding base address of the first logical core is BSP_SMM_BASE, and the size of the SMRAM M2 of each logical core is the same (e.g., 64K bytes), the corresponding base address of a certain second logical core may be determined as BSP_SMM_BASE+APIC_IDxdelta by the association between the base addresses. Wherein, delta is the size of the SMRAM M2 of each logical core, the APIC_ID of the first logical core is 0, the APIC_ID of the first second logical core is 1, the APIC_ID of the second second logical core is 2, and so on.

In some embodiments, the address offset of the core configuration information and the address offset of the state save area are the address offsets relative to the base address of the SMRAM M2 of the corresponding logical core. The present disclosure does not limit thereto.

In step S203, the first logical core executes BIOS to set the core configuration information of each logical core in the SMM. In some embodiments, the core configuration information includes a plurality of information fields. Each information field is configured to store the corresponding core configuration information or the memory address of the corresponding core configuration information. In this embodiment, the core configuration information includes the corresponding mode-setting information of the target operating mode required by the logical core to set operating mode before executing the SMI handler, and the operating environment information required by the logical core to set operating environment before executing the SMI handler. Accordingly, the logical core may set the operating mode of the logical core to the target operating mode based on the mode-setting information, and set the operating environment of the logical core based on the operating environment information. In some embodiments, the target operating mode may be a 64 bit mode, a 32 bit mode, etc., and this disclosure does not limit thereto. The operating environment information may indicate the setting value of each register corresponding to the operating environment (e.g., each general purpose register RAX, RBX, RCX, RDX, etc.) in the SMM. The mode-setting information may indicate the setting value of each register corresponding to the target operating environment.

In some embodiments, the core configuration information may also include at least one of mode-control information, access-control information, and interrupt-source-legality information. The mode-control information is configured to indicate the logical core to enter the target operating mode. The access-control information is configured to indicate the access authority to target resources. The target resources include at least one of the following: IO ports, registers, PCI devices, memory spaces and other resources accessible to logical cores. This disclosure does not limit thereto. The interrupt-source-legality information is configured to indicate the legality of SMI. In some embodiments, the interrupt-source-legality information may be implemented in the form of a software SMI whitelist.

In step S204, the first logical core executes the BIOS to notify each logical core to store its own core configuration information into its corresponding memory space for the core configuration information as shown in FIG. 9. The memory address of the core configuration information is determined by the base address of the SMRAM M2 of the first logical core. For example, the aforementioned formula BSP_SMM_BASE+APIC_ID×delta may be configured to calculate the base address of the corresponding SMRAM M2 of the logical core. Then, the base address of the corresponding SMRAM M2 of the logical core is added with the corresponding address offset of the configuration information to obtain the corresponding address of the memory space for the core configuration information of the logical core.

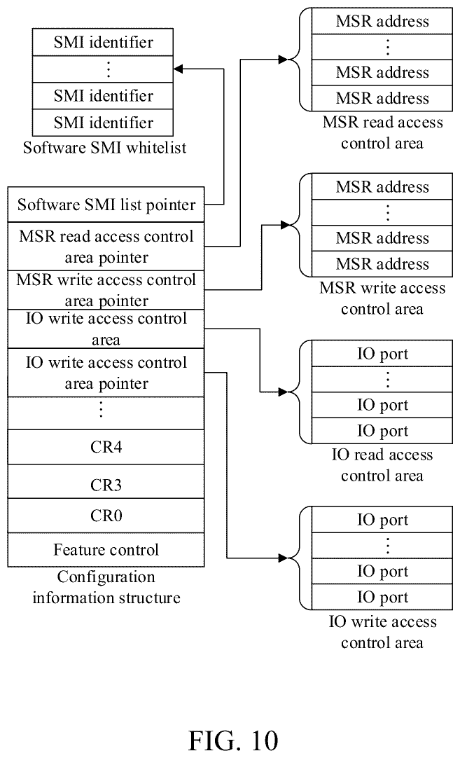

FIG. 10 shows a schematic diagram of a configuration information structure according to an embodiment of the present disclosure. In some embodiments, the configuration information structure (SMM_ENTRY_STRUCT) may include multiple information fields, which are set in sequence as shown in FIG. 10. As shown in FIG. 10, each information field in the configuration information structure can directly store the corresponding core configuration information, such as the stored setting values of CR0, CR3, CR4 and other registers. Each information field in the configuration information structure can also store an address indicating the location of the corresponding core configuration information (i.e., a pointer) to achieve resource access control in SMM to improve system security. For example, the IO write access control area pointer and the IO read access control area pointer are set for the access control on the IO port. The MSR read access control area pointer and the MSR write access control area pointer are set for the access control on the MSR. The software SMI list pointer is set for interrupt-source-legality information.

In some embodiments, as shown in FIG. 10, each pointer in the configuration information structure (IO write access control area pointer, IO read access control area pointer, MSR read access control area pointer, MSR write access control area pointer and software SMI list pointer) can be stored in the corresponding field according to the configured structure. Each pointer can indicate a memory space.

Wherein, as shown in FIG. 10, the IO write access control area pointer and the IO read access control area pointer respectively point to the IO write access control area and IO read access control area, where at least an address of IO port is stored. The logical core is not allowed to write data to the corresponding IO port indicated by the address of each IO port in the IO write access control area. The logical core is not allowed to read data from the corresponding IO port indicated by the address of each IO port in the IO read access control area.

Wherein, as shown in FIG. 10, the MSR write access control area pointer and the MSR read access control area pointer respectively point to the MSR write access control area and MSR read access control area, where at least an address of MSR is stored. The logical core is not allowed to write data to the corresponding MSR of each MSR address in the MSR write access control area. The logical core is not allowed to read data from the corresponding MSR of each MSR address in the MSR read access control area.

Wherein, as shown in FIG. 10, a software SMI whitelist is stored in the memory space pointed by the software SMI list pointer. The software SMI whitelist includes at least one SMI identifier. The SMI identifier is configured to indicate a corresponding SMI. According to the SMI identifier, the legality of the SMI handler may be determined before the SMI handler is executed. This saves processing time and improves system security. In an embodiment, the SMI identifier is an 8-bit number. The SMI identifier may be written into the port register by the software that triggers the SMI, and can be read by the SMI handler to determine which software triggers the SMI.

In some embodiments, as shown in FIG. 10, the length of each information field in the configuration information structure may be a default length, such as 32 bits or 64 bits. The configuration information structure also includes the Feature Control information field. The Feature Control information field is configured to set some specific functions that need to be implemented after entering the system management mode. For example, after the logical core enters the SMM, whether to support mode switching control, whether to support access control (i.e., whether to support access control based on IO write access control area pointer, IO read access control area pointer, MSR write access control area pointer, MSR read access control area pointer, software SMI list pointer, etc.), etc., can be set according to the Feature Control information field.

For example, if the target operating mode is 64 bit mode, the core configuration information can be set as follows:
CR0: The PG bit of the CR0 register is set to 1, which enables paging by default, and the PE bit of the CR0 register is set to 1, which enables the protection mode by default.
CR3: CR3 points to the address of the root page tables where the SMI handler's code and data are located.
CR4: CR4 includes some basic configurations of the processor. For example, the paging type is configured by setting the Physical Address Extensions (PAE) bit of the CR4 register.
EFER: The LME bit of the EFER register is set to 1 to enable IA32-e mode.

Segment registers such as DS/ES/FS/GS are all set to 0.

CS: the L bit of the CS register is set to 1 to enable 64 bit mode.

The above core configuration information is loaded into the corresponding register of the logical core, so that the logical core may be directly in the 64 bit mode after entering the system management mode without the need to switch from real mode to 64 bit mode when executing the SMI handler. This can improve the execution efficiency of the SMI handler.

In summary, through the initialization setting provided in Example 1 shown in FIGS. 7 to 10, there is no need to set the base address of the SMRAM M2 serially for each logical core. This shortens the initialization time and improves the execution efficiency of the initialization. The mode-setting information included in the core configuration information allows each logical core to enter the target operating mode directly through the hardware setting every time it enters the system management mode. The logical core does not need to perform the fixed operation of mode switching when executing the SMI handler. This improves the execution efficiency of executing the SMI handler. In addition, the core configuration information may be customized according to actual needs (e.g., customized setting for general-purpose registers) to reduce the setting operations in the SMI handler. This further improves the execution efficiency of the SMI handler.

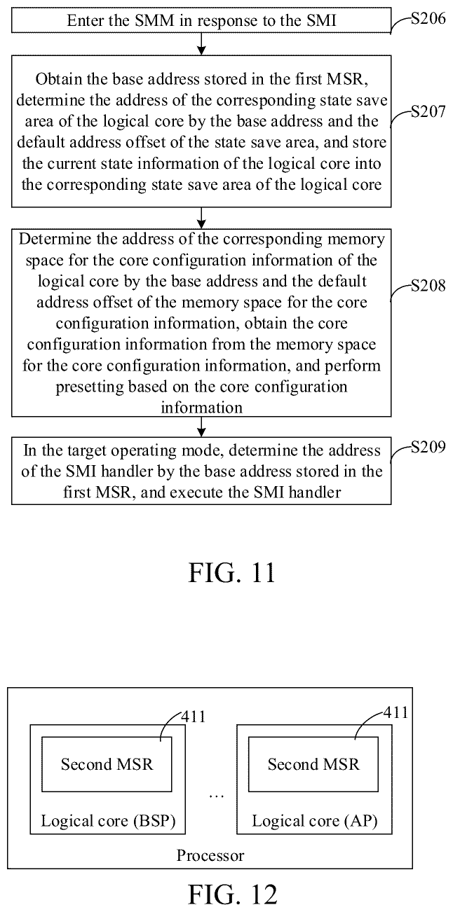

FIG. 11 shows a flowchart of response execution steps in Example 1 according to an embodiment of the present disclosure. After completing the initialization setting of the SMRAM, any logical core in the processor can handle the SMI. The response execution steps shown in FIG. 11 are the specific processes for the logical core to handle SMIs. Any logical core in the processor shown in FIG. 7 can execute the response execution steps, and one or more logical cores in the processor may perform this response execution step simultaneously. As shown in FIG. 11, the response execution steps may include steps S206 to S209. Wherein, steps S206 to S208 are implemented by the hardware of the logical core, and step S209 is implemented by executing the SMI handler by the logical core.

In step S206, the logical core enters the SMM in response to the SMI. Step S206 is the same as step S105 in FIG. 4, thus not described again here. Then, step S207 is executed.

In step S207, the logical core obtains the stored base address (i.e., the base address BSP_SMM_BASE of the SMRAM M2 of the first logical core) from the first MSR. Then, the logical core determines the address of its corresponding state save area based on the base address, and stores its current state information into its corresponding state save area. Wherein, the state information may be information indicating the current operating state and environment of the logical core, such as context, etc. The context may include the values of each register (such as RAX, RBX, RCX, RDX, etc.). This disclosure is not limit thereto.

Wherein, there are differences in the way the first logical core and the second logical core determine the address of the corresponding state save area based on the base address stored in the first MSR. As shown in FIG. 9, after the first logical core obtains the base address from the first MSR, since the first MSR itself stores the base address of the corresponding SMRAM M2 of the first logical core, the base address can be directly added to the address offset of the default state save area to get the address of the state save area of the first logical core. After obtaining the base address from the first MSR, the second logical core determines the base address of the SMRAM M2 of the second logical core based on the association between the base address of the corresponding SMRAM M2 of the first logical core and the base address of the corresponding SMRAM M2 of the second logical core in the first MSR. Then, the base address of the corresponding SMRAM M2 of the second logical core and the address offset of the state save area can be added to get the address of the corresponding state save area of the second logical core. The aforementioned paragraph has described how to calculate the base address of the SMRAM M2 of the corresponding logical core based on the formula BSP_SMM_BASE+APIC_ID×delta, and how to further calculate the address of the state save area of the logical core. These will not be described again here.

In step S208, the logical core determines the address of the memory space for the core configuration information in the corresponding SMRAM M2 of the logical core by the base address in the first MSR. The logical core obtains the core configuration information from the memory space for the core configuration information, and performs presetting based on the obtained core configuration information.

Wherein, there are differences in the way the first logical core and the second logical core determine the address of the memory space for the corresponding core configuration information based on the base address stored in the first MSR. As shown in FIG. 9, after obtaining the base address from the first MSR, the first logical core may obtain the address of the memory space for the core configuration information of the first logical core by directly adding the base address and the address offset of the core configuration information. The second logical core can add the base address of its corresponding SMRAM M2 determined in step S207 and the address offset of the core configuration information to obtain the address of the memory space for the corresponding core configuration information of the second logical core. The aforementioned paragraph has described how to calculate the base address of the SMRAM M2 of the corresponding logical core based on the formula BSP_SMM_BASE+APIC_ID×delta, and how to further calculate the address of the memory space for the core configuration information of the logical core. Thus, these will not be described again here.

In some embodiments, the presetting may include: the logical core set mode according to the corresponding mode-setting information (i.e., set the value of the corresponding register to the setting value indicated in the mode-setting information) to enter the target operating mode; each logical core is set according to the corresponding operating environment information (i.e., set the value of the corresponding register to the setting value indicated in the operating environment information) to complete the operating environment setting. The specific setting has been described in the aforementioned paragraph, thus not described again.

In some embodiments, the logical core needs to check whether the core configuration information is correct before loading the core configuration information into the register. If there is an error, the computer system can be shut down directly. After the logical core confirms that the core configuration information is correct, the core configuration information is loaded into the corresponding registers.

In step S209, in the target operating mode, the logical core determines the address of the SMI handler according to the base address of the corresponding SMRAM M2 of the logical core, and executes the SMI handler. As shown in FIG. 9, the first logical core can directly use the base address obtained from the first MSR as the start address of the SMI handler, and the second logical core can directly use the base address of the corresponding SMRAM M2 determined in the above step S207 as the start address of the SMI handler. Wherein, the RSM instruction is executed at the end of the SMI handler (i.e., after all function codes in the SMI handler are executed) to exit the SMM.

Through the response execution steps provided in Example 1 shown in FIG. 11, the address of the state save area, the address of the memory space for the core configuration information, and the address of the SMI handler can be directly determined based on the base address from the first MSR. The mode-setting information included in the configuration information allows each logical core to directly enter the target operating mode through hardware setting each time it enters the SMM. When the SMI handler is executed, there is no need to perform the fixed operation of mode switching. This can improve the execution efficiency of the SMI handler. In addition, the core configuration information can be customized according to actual needs (e.g., customize setting for general-purpose registers) to reduce the setting operations in the execution of the SMI handler to further improve the execution efficiency of the SMI handler.

In another embodiment, FIG. 8 may not include steps S203 and S204, and the SMRAM M2 in FIG. 9 may not include the memory space for the core configuration information. Correspondingly, the hardware of each logical core contains default core configuration information, and in step S208 of FIG. 11, the hardware of each logical core presets the logical core through the default core configuration information.

Example 2 (described below with reference to FIG. 9 and FIG. 12-FIG. 14):

FIG. 12 shows a block diagram of a processor of Example 2 according to an embodiment of the present disclosure. As shown in FIG. 12, the method is applied to the processor shown in FIG. 12, which includes one or more logical cores, and each logical core includes a second MSR 411. Wherein, the second MSR 411 in each logical core may be fabricated in the logical core as shown in FIG. 12, or may be fabricated outside the logical core. This disclosure does not limit thereto. The processor includes a first logical core (e.g., BSP) and at least one second logical core (e.g., AP). For simplicity, FIG. 12 schematically shows a processor with two logical cores.

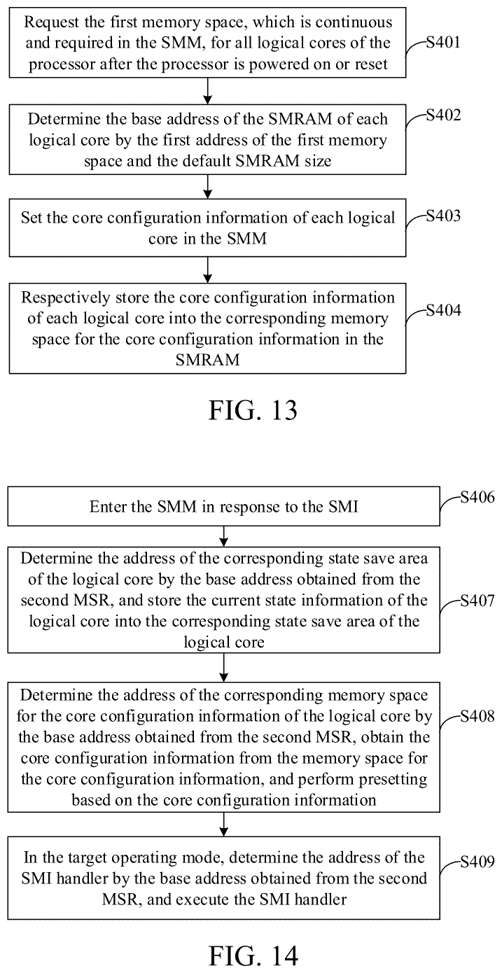

FIG. 13 shows a flowchart for initialization setting in Example 2 according to an embodiment of the present disclosure. As shown in FIG. 13, the initialization setting in this method may include steps S401 to S404.

In step S401, after the processor is powered on or reset, the first logical core of the processor executes the BIOS to request the first memory space MM as shown in FIG. 9, which is required in the SMM, for all logical cores of the processor. The first memory space MM is a continuous memory space. The way to request the continuous first memory space MM can be referred in the step S201 above, thus not described again to avoid redundancy.

In this embodiment, the first memory space MM shown in FIG. 9 is requested first in the initialization. Then, a SMRAM M2 is allocated for each logical core as shown in FIG. 9. The implementation of the first memory space MM and the SMRAM M2 can be referred above, thus not described again to avoid redundancy.

In step S402, the first logical core executes the BIOS to determine the base address of the SMRAM M2 of each logical core by the start address of the first memory space MM and the default size of the SMRAM, and notifies each logical core to store its respective corresponding base addresses into the second MSR. Wherein, the start address of the first memory space MM can be directly served as the base address of the SMRAM M2 of the first logical core. Then, the base address of the SMRAM M2 of each second logical core is calculated based on the corresponding base address of the first logical core and the association between the base addresses of the first logical core and each second logical core. The implementation of the calculation is the same as the way mentioned above to calculate the corresponding base address of each second logical core based on the corresponding base address of the first logical core and the association between the base addresses of the first logical core and each second logical core. The implementation of the calculation can be referred in the aforementioned paragraph, and therefore it is not described again, to avoid redundancy.

Wherein, the first logical core can send an inter-processor interrupt (IPI) to each logical core after determining the corresponding base address of each logical core. This makes the logical core that receives the IPI store the base address of its corresponding SMRAM M2 into its respective second MSR. Each logical core that receives the IPI can execute in parallel, so the execution efficiency gets higher. Specifically, the first logical core writes the start address of the SMRAM M2 allocated to each logical core into different locations of the memory accessible to all logical cores. Then, the first logical core sends the IPI to all second logical cores. In response to the received IPI, each second logical core begins to execute the initialization interrupt handler (the initialization interrupt handler of each second logical core can be written beforehand, assigned an interrupt vector, and set as each interrupt handler of the second logical core by the processor developer). By executing the initialization interrupt handler, each second logical core reads the start address of its own SMRAM M2 from the corresponding location in the memory accessible to all logical cores. For example, the first logical core writes the start address of the SMRAM M2 allocated to the first second logical core into the memory space with address addr1 in the shared memory (all logical cores can access the shared memory), writes the start address of the SMRAM M2 allocated to the second logical core into the memory space with address addr2 in the shared memory, and so on. Then, the first logical core sends the IPI to all second logical cores. In response to the received IPI, each second logical core begins to execute an initialization interrupt handler to read the start address of its respective SMRAM M2 from the memory space with the corresponding address in the shared memory. For example, the first second logical core can read the start address of the corresponding SMRAM M2 from the memory space with address addr1 in the shared memory; the second logical core can read the start address of the corresponding SMRAM M2 from the memory space with address addr2 in the shared memory.

In step S403, the first logical core executes the BIOS to set the core configuration information of each logical core in the SMM.

In step S404, the first logical core executes the BIOS to store the core configuration information of each logical core into the corresponding memory space for the core configuration information in the first memory space MM as shown in FIG. 9. The address of the corresponding memory space for the core configuration information of each core configuration information is determined by the base address of the SMRAM M2 of each logical core.

The implementation of the above-mentioned steps S403 to S404 is similar to the above-mentioned steps S203 to S204. It can be referred in the aforementioned paragraph for more detailed description, thus not described again to avoid redundancy.

Through the initialization setting provided in Example 2 shown in FIG. 13, each logical core can execute the initialization operation of the SMM in parallel. Thus, the initialization of the SMM is more efficient. In addition, the base address of the SMRAM M2 set for each logical core is stored in its respective second MSR. Subsequently, the time for each logical core to obtain the base address of its corresponding SMRAM M2 can be reduced. The mode-setting information contained in the core configuration information allows each logical core to directly enter the target operating mode through hardware setting each time it enters the SMM. The logical core does not need to perform the fixed operation of mode switching when executing the SMI handler. This also improves the execution efficiency of the SMI handler. The core configuration information can be customized according to actual needs. This further reduces the setting time during executing the SMI handler, and further improves the execution efficiency of the SMI handler.

FIG. 14 shows a flowchart of response execution steps in Example 2 according to an embodiment of the present disclosure. As shown in FIG. 14, in this method, after the initialization setting of the SMM is completed, any logical core in the processor shown in FIG. 12 can handle the SMI. The response execution step shown in FIG. 14 is a specific process for the logical core to handle the SMI. Any logical core in the processor shown in FIG. 12 can execute the response execution step, and one or more logical cores in the processor may execute the response execution step at the same time. As shown in FIG. 14, the response execution steps may include steps S406 to S409. Wherein, steps S406 to S408 are implemented by the hardware of the logical core, and step S409 is implemented by executing the SMI handler by the logical core.

In step S406, the logical core enters the SMM in response to the SMI.

In step S407, the logical core reads the corresponding base address (i.e., the base address of the SMRAM of the logical core) from the corresponding second MSR, determines the address of the corresponding state save area by the obtained base address, and then stores the current state information of the logical core into the corresponding state save area according to the determined address of the state save area. Wherein, as shown in FIG. 9, the logical core can directly add the respective base address and the address offset of the state save area to obtain the address of the corresponding state save area of the logical core in the allocated SMRAM M2.

In step S408, the logical core determines the address of the corresponding memory space for the core configuration information of the logical core according to the base address in the corresponding second MSR, obtains the core configuration information from the memory space for the core configuration information, and performs presetting based on the obtained core configuration information. Wherein, as shown in FIG. 9, after obtaining the base address from the corresponding second MSR, the logical core can directly add the base address and the address offset of the core configuration information to obtain the address of the memory space for the core configuration information of the logical core.

In some embodiments, the presetting may include: the logical core set mode according to the corresponding mode-setting information (i.e., set the value of the corresponding register to the setting value indicated in the mode-setting information to enter the target operating mode); each logical core is set according to the corresponding operating environment information (i.e., set the value of the corresponding register to the setting value indicated in the operating environment information) to complete the operating environment setting. The specific setting has been described in the aforementioned paragraph, thus not described again.

In some embodiments, before loading the core configuration information into the register, the logical core needs to check whether the core configuration information is correct. If there is an error, the computer system may be shut down directly. After confirming that the core configuration information is correct, the logical core loads the core configuration information into the corresponding registers.

In step S409, in the target operating mode, the logical core determines the address of the SMI handler by the base address obtained in the second MSR, and executes the SMI handler. Wherein, as shown in FIG. 9, the logical core can directly use the base address obtained in the second MSR as the start address of the SMI handler. Wherein, the RSM instruction is executed at the end of the SMI handler (i.e., after all function codes in the SMI handler are executed) to exit the SMM.

Through the response execution steps provided in Example 2 shown in FIG. 14, each logical core can directly determine the address of the state save area, the address of the memory space for the core configuration information and the address of the entrance of the SMI handler by the base address stored in the second MSR. The mode-setting information contained in the core configuration information allow each logical core to directly enter the target operating mode through hardware setting each time it enters the system management mode. The logical core does not need to perform the fixed operation of mode switching when executing the SMI handler. This can improve the execution efficiency of the SMI handler. In addition, since the core configuration information can be customized according to actual needs, the setting operations required to be done in the SMI handler can be further reduced. This further improves the execution efficiency of the SMI handler.

In another embodiment, FIG. 13 may not include steps S403 and S404, and the SMRAM M2 in FIG. 9 may not include memory space for the core configuration information. Correspondingly, the hardware of each logical core contains the default core configuration information. In step S408 of FIG. 14, the hardware of each logical core presets the logical core through the default core configuration information.

Example 3 (described below with reference to FIG. 12, FIG. 14 to FIG. 16):

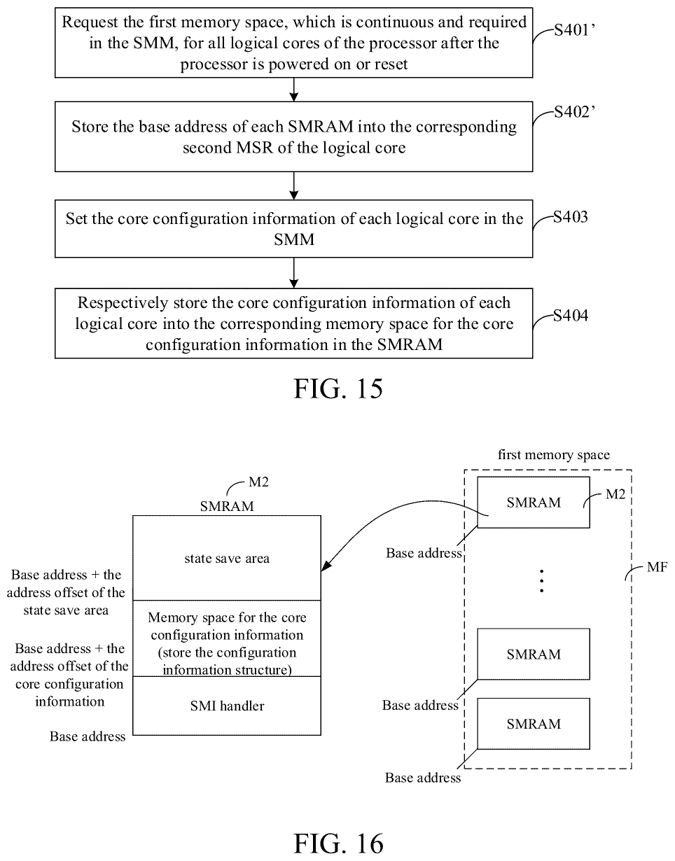

This method is still applied to the processor shown in FIG. 12. The method provided in Example 3 is different from the method provided in Example 2 only in the initialization setting. FIG. 15 shows a flowchart for the initialization setting in Example 3 according to an embodiment of the present disclosure. As shown in FIG. 15, the initialization setting in this method includes step S401′, step S402′, step S403 and step S404. The response execution steps in this method include the steps shown in FIG. 14. That is, the methods provided in Example 3 and Example 2 only differ in the first two steps of the initialization setting, and the remaining steps are the same. To avoid redundancy, only the different steps, S401′ and S402′, are described. The remaining steps and related benefits can be referred in Example 2 above, thus not repeated.

Wherein, in step S401′, after the processor is powered on or reset, the first logical core of the processor executes the BIOS to request the SMRAM M2 required in the SMM as shown in FIG. 16 for each logical core.

FIG. 16 shows a schematic diagram of the first memory space and the SMRAM in Example 3 according to an embodiment of the present disclosure. In some embodiments, as shown in FIG. 16, the SMRAM M2 of each logical core constitutes the first memory space MF. The SMRAM M2 of each logical core in the first memory space MF may be in a discontinuous memory space. That is, the first memory space MF is a discontinuous memory space and each SMRAM M2 is a continuous memory space. To facilitate unified management, the SMRAM M2 of each logical core may have the same default SMRAM size. The implementation of the SMRAM M2 can be inferred by analogy from the description of the SMRAM M2 in FIG. 9 above, and therefore it is not described again, to avoid redundancy.

In step S402′, the first logical core executes the BIOS to determine the start address of the SMRAM M2 of each logical core as the corresponding base address of the logical core, and notifies each logical core to store its respective corresponding SMBase into its respective second MSR by sending an inter-processor interrupt to each logical core. As for how to notify each logical core to store its corresponding SMBase into its second MSR by sending an inter-processor interrupt to each logical core, it has been described above, and therefore it is not described again here. Then, step S403 to step S404 are executed.

In the embodiment of Example 3, since the first memory space can be a discontinuous memory space, the memory space can be utilized more effectively, and the fragmentation of the memory space can be reduced.

In another embodiment, FIG. 15 may not include steps S403 and S404, and the SMRAM M2 of FIG. 16 may not include memory space for the core configuration information. Correspondingly, the hardware of each logical core contains the presetting core configuration information. In step S408 of FIG. 14, the hardware of each logical core presets the logical core through the presetting core configuration information.

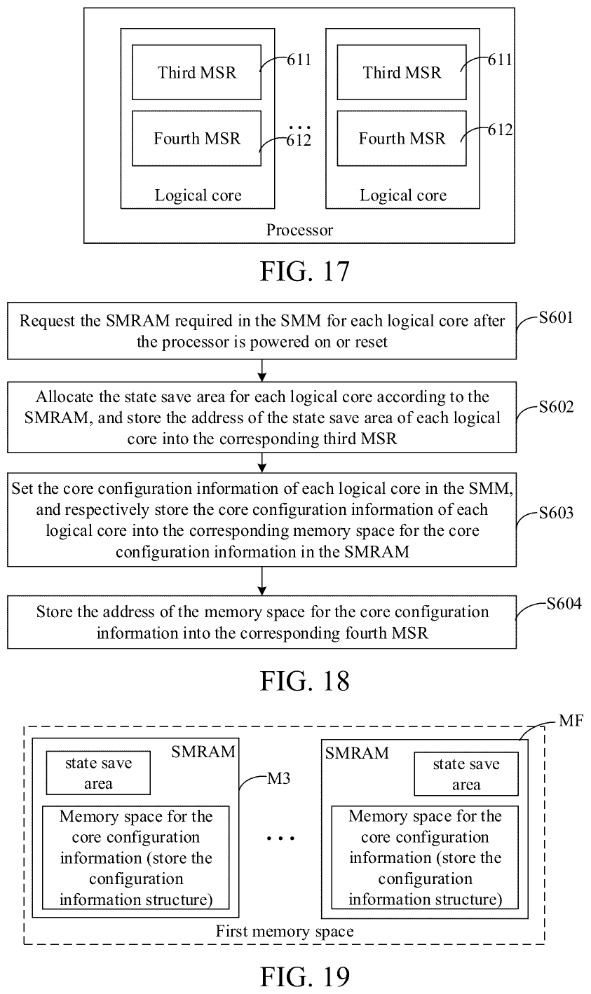

Example 4 (described below with reference to FIG. 17-FIG. 24):

FIG. 17 shows a block diagram of a processor applied in Example 4 according to an embodiment of the present disclosure. This method is applied to the processor shown in FIG. 17, which may include one or more logical cores. A third MSR 611 and a fourth MSR 612 are provided for each logical core. The third MSR 611 of each logical core can be fabricated in the logical core as shown in FIG. 17, or can be fabricated outside the logical core. Similarly, the fourth MSR 612 of each logical core can be fabricated in the logical core as shown in FIG. 17, or can be fabricated outside the logical core. For simplicity, FIG. 17 only schematically shows that the processor includes two logical cores.

FIG. 18 shows a flowchart for initialization setting in Example 4 according to an embodiment of the present disclosure. As shown in FIG. 18, the initialization setting in this method may include steps S601 to S604.

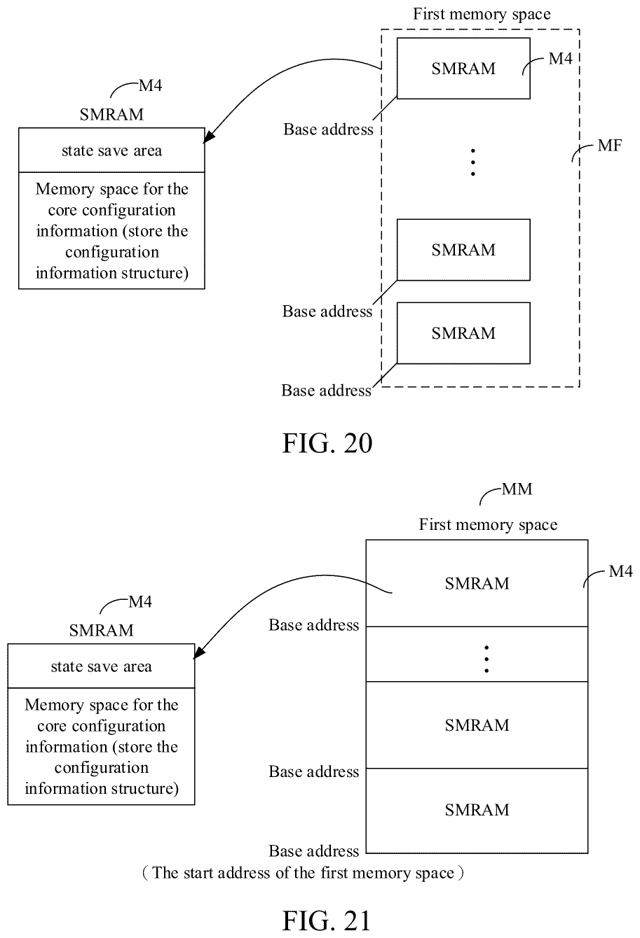

In step S601, after the processor is powered on or reset, the logical core of the processor (e.g., the first logical core (e.g., BSP) among multiple logical cores) requests the first memory space required in the SMM for the processor by executing the BIOS. The first memory space can be a discontinuous first memory space MF as shown in FIG. 19 and FIG. 20 above, or a continuous memory space MM as shown in FIG. 21. It only needs to ensure that the state save area of each logical core is a continuous memory space, and the memory space for the core configuration information of each logical core is a continuous memory space. This disclosure does not limit thereto.

In step S602, the first logical core executes the BIOS to allocate a state save area to each logical core according to the first memory space, and stores the address of the state save area of each logical core into the corresponding third MSR of the logical core. Different logical cores have different state save areas. Wherein, the first logical core notify each logical core to store the address of its respective corresponding state save area into the set third MSR by sending IPI to each logical core.

FIG. 19-FIG. 21 show schematic diagrams of the first memory space and the SMRAM in Example 4 according to an embodiment of the present disclosure. As shown in FIG. 19, if the first memory space MF applied for in Example 4 is a discontinuous memory space, a memory space as the state save area and a memory space for the core configuration information can be allocated from the first memory space MF for each logical core respectively. The SMRAM M3 of the same logical core is a discontinuous memory space. That is, the state save area and the memory space for the core configuration information in the SMRAM M3 of the same logical core is not continuous.

In some embodiments, as shown in FIG. 20, if the first memory space MF applied for in Example 4 is a discontinuous memory space, each logical core can be allocated a memory space as the state save area and a memory space for the core configuration information from the first memory space MF respectively. The SMRAM M4 of the same logical core is a continuous memory space. That is, in the SMRAM M4 of the same logical core, the state save area is continuous with the memory space for the core configuration information.

In some embodiments, as shown in FIG. 21, if the first memory space MM in Example 4 is a continuous memory space, a memory space can be allocated, for each logical core, as the state save area and a memory space for the core configuration information from the first memory space MF respectively. The SMRAM M4 of the same logical core is a continuous memory space. That is, in the SMRAM M4 of the same logical core, the state save area is continuous with the memory space for the core configuration information. In another embodiment, the first memory space MM in Example 4 is a continuous memory space, the SMRAM M4 of the same logical core is a discontinuous memory space. That is, in the SMRAM M4 of the same logical core, the state save area is discontinuous with the memory space for the core configuration information.

In some embodiments, each logical core can be controlled to form a corresponding saving area structure according to the address of the allocated state save area, and store the saving area structure into the corresponding third MSR. Specifically, how to notify each logical core to store the address of its respective corresponding state save area into the set third MSR by sending IPI to each logical core can be referred in the aforementioned description of setting the second MSR, thus not described in detail here.

In step S603, the first logical core executes the BIOS to set the core configuration information of each logical core in the SMM, and stores each core configuration information into the memory space for the core configuration information in the corresponding SMRAM (as shown in FIG. 19-FIG. 21). Wherein, the core configuration information includes the corresponding mode-setting information of the target operating mode, which is required for the logical core to set mode before executing the SMI handler. The core configuration information also includes the operating environment information, which is required for the logical core to configure operating environment before executing the SMI handler, and includes the address of the SMI handler.

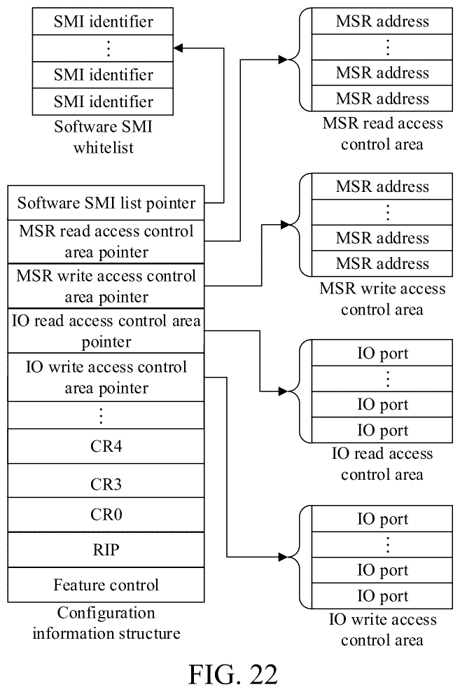

FIG. 22 shows a schematic diagram of a configuration information structure according to an embodiment of the present disclosure. In this embodiment, after the core configuration information is determined, the configuration information structure of each core configuration information as shown in FIG. 22 can be formed according to the core configuration information of each logical core. Then, each configuration information structure is stored in the corresponding memory space for the core configuration information in the SMRAM (as shown in FIG. 19-FIG. 21). Wherein, the configuration information structure includes a plurality of information fields. Each information field is configured to store the corresponding core configuration information or the memory address of the corresponding core configuration information.

The difference between the configuration information structure shown in FIG. 22 and the configuration information structure shown in FIG. 10 is that the configuration information structure shown in FIG. 22 further includes the address of the SMI handler (i.e., the RIP shown in FIG. 22). The implementation of the core configuration information structure can be inferred by analogy from the description of the configuration information structure shown in FIG. 10 above, thus not described in detail to avoid redundancy.

In step S604, the first logical core executes the BIOS to store the address of each memory space for the core configuration information into the corresponding fourth MSR. Wherein, the first logical can notify each logical core to store a pointer indicating the address of the memory space for the core configuration information where the configuration information structure is located in the corresponding fourth MSR by sending IPI to each logical core. Specifically, how to notify each logical core to store the address of its respective corresponding memory space for the core configuration information into the set fourth MSR by sending IPI to each logical core can be referred in the aforementioned description of setting the second MSR, thus not described in detail here.

Through the initialization setting provided in Example 4 shown in FIG. 18, the setting for the state save area and the core configuration information of each logical core can be implemented in parallel (i.e., each logical core can perform related setting operations in parallel after receiving an IPI). The setting is fast and takes a short time, and the rational use of memory space is realized to avoid memory fragmentation and facilitate memory management. Each time each logical core enters the SMM, the logical core does not need to perform the fixed operation of mode switching when executing the SMI handler. This can improve the execution efficiency of the SMI handler. In addition, since the core configuration information can be customized according to actual needs, the setting operations required in the SMI handler can be further reduced. This further improves the execution efficiency of the SMI handler. In this way, through the presetting of steps S601 to S604, it is ensured that each logical core subsequently can respond to the SMI and execute the SMI handler.

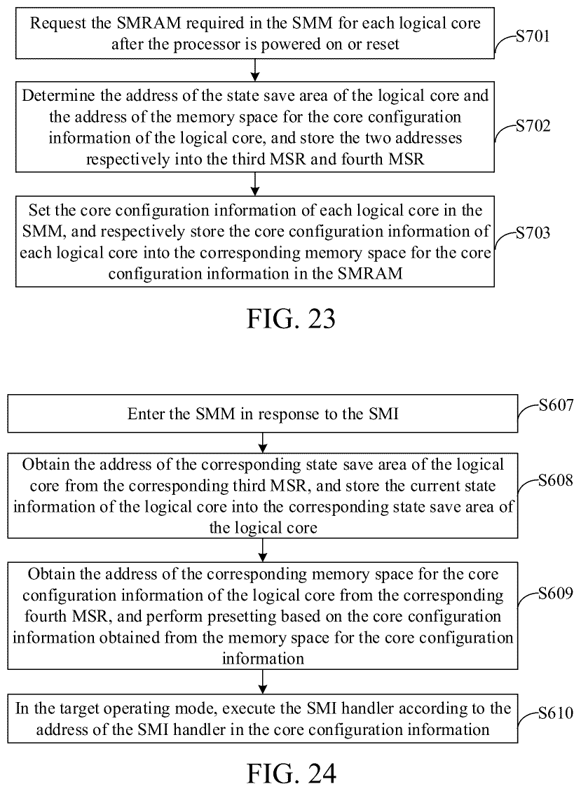

FIG. 23 shows a flowchart for initialization setting in Example 4 according to an embodiment of the present disclosure. The execution steps of the initialization setting in Example 4 can be set according to actual needs, and can be set as shown in FIG. 18, or can be set as step S701 to step S703 as shown in FIG. 23.

As shown in FIG. 23, step S701 is the same as the above-mentioned step S601, thus not described again to avoid redundancy. In step S702, the first logical core executes the BIOS to allocate a state save area and a memory space for the core configuration information to each logical core according to the first memory space. The first logical core also stores the address of the state save area of each logical core into the corresponding third MSR of each logical core, and stores the address of the memory space for the core configuration information into the corresponding fourth MSR of each logical core. Wherein, the first logical core can notify each logical core to store the address of its respective corresponding state save area and the address of its respective corresponding memory space for its core configuration information into the corresponding third MSR and fourth MSR. Step S703 is the same as step S603, which is described above, thus not described again to avoid redundancy.

FIG. 24 shows a flowchart of response execution steps in Example 4 according to an embodiment of the present disclosure. As shown in FIG. 24, in this method, after the completion of initialization setting, the method further include a response execution step. Any logical core in the processor shown in FIG. 17 can execute this response execution step, and one or more logical cores may perform this response execution step simultaneously. As shown in FIG. 24, the response execution steps may include steps S607 to S610. Wherein, steps S607 to S609 are implemented by the hardware of the logical core, and step S610 is implemented by executing the SMI handler by the logical core.

In step S607, the logical core enters the SMM in response to the SMI.

In step S608, the logical core obtains the address of the its corresponding state save area from the corresponding third MSR, and stores its current state information into the corresponding state save area based on the address of the state save area. Wherein, each logical core can first obtain the state save area structure from the corresponding third MSR, further determine the address of the state save area according to the state save area structure, and then store its current state information according to the address of the state save area.

In step S609, the logical core obtains the address of the memory space for the core configuration information where its corresponding core configuration information is located from the corresponding fourth MSR. Then, the logical core is preset based on the core configuration information obtained from the memory space for the core configuration information. Wherein, the logical core can first obtain the address of the core configuration information structure from the corresponding fourth MSR. Then, the logical core obtain the configuration information structure from the determined address of the core configuration information structure, and then determine each core configuration information by the core configuration information structure.

In some embodiments, the presetting may include: the logical core sets operating mode according to the corresponding mode-setting information (i.e., set the value of the corresponding register to the setting value indicated in the mode-setting information to enter the target operating mode); each logical core set operating environment according to the corresponding operating environment information (i.e., set the value of the corresponding register to the setting value indicated in the operating environment information), and the operating environment setting is completed. The specific setting has been described in the aforementioned paragraph, thus not described again here.

In some embodiments, the logical core needs to check whether the core configuration information is correct before loading the core configuration information into the register. If there is an error, the computer system can be shut down directly. After confirming that the core configuration information is correct, the logical core loads the core configuration information into the corresponding registers.

In step S610, the logical core executes the SMI handler in the target operating mode according to the address of the SMI handler in the core configuration information. Wherein, the RSM instruction is executed at the end of the SMI handler to exit the SMM.

Through the response execution steps provided in Example 4 shown in FIG. 24, the setting for the state save area and the core configuration of each logical core can be implemented in parallel (i.e., each logical core can execute related setting operations in parallel after receiving an IPI). The setting is fast and takes a short time. The rational utilization of memory space is realized to avoid memory fragmentation and facilitate memory management. Each time each logical core enters the SMM, the logical core does not need to perform the fixed operation of mode switching when executing an SMI. This improves the execution efficiency of the SMI. In addition, since the core configuration information can be customized according to actual needs, the setting operations in the SMI handler can be further reduced. This further improves the execution efficiency of the SMI handler.

Example 5 (described below with reference to FIG. 12):

This method is applied in the processor shown in FIG. 12. The method provided in Example 5 is different from the method provided in Example 4 only in the storage of addresses. In Example 5, in the initialization setting, the address of the state save area and the address of the memory space for the core configuration information of each logical core are stored in the second MSR of the logical core. In the response execution step, each logical core obtains the address of its corresponding state save area and the address of its corresponding memory space for core configuration information from its respective second MSR. The remaining steps are the same. Thus, the benefits of the remaining steps and related steps can be referred in Example 4 above, thus not described in detail here.

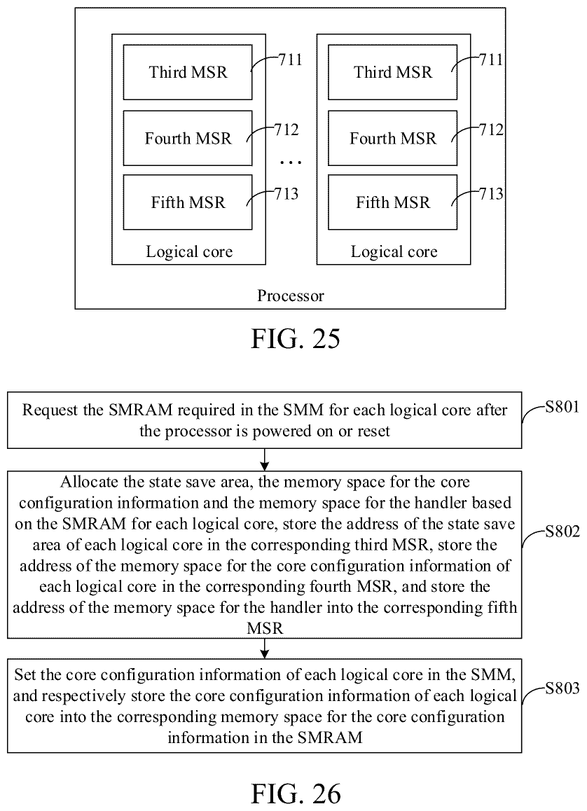

Example 6 (described below with reference to FIG. 10, FIG. 20, FIG. 21, FIG. 25 to FIG. 29):

FIG. 25 shows a block diagram of a processor applied in Example 6 according to an embodiment of the present disclosure. This method is applied in the processor shown in FIG. 25, which may include one or more logical cores. A third MSR 711, a fourth MSR 712, and a fifth MSR 713 are provided for each logical core. The MSR of each logical core (the third MSR 711, the fourth MSR 712, and the fifth MSR 713) can be fabricated in the logical core as shown in FIG. 25, or can be fabricated outside the logical core. This disclosure does not limit thereto. For simplicity, FIG. 25 only schematically shows that the processor includes two logical cores.

The differences between Example 6 and Example 4 is that: the third MSR 711 is configured to store the address of the state save area of the corresponding logical core, the fourth MSR 712 is configured to store the address of the memory space for the core configuration information of the corresponding logical core, and the fifth MSR 713 is configured to store the address of the SMI handler. Wherein, the core configuration information in Example 6 only includes mode-setting information and operating environment information. That is, the memory space for the core configuration information in Example 6 stores the configuration information structure as shown in FIG. 10.

FIG. 26 shows a flowchart for initialization setting in Example 6 according to an embodiment of the present disclosure. As shown in FIG. 26, the initialization setting in this method may include steps S801 to S803.

In step S801, after the processor is powered on or reset, the logical core of the processor (i.e., the first logical core (e.g., BSP) among multiple logical cores) requests the SMRAM required in SMM for each logical core by executing the BIOS.

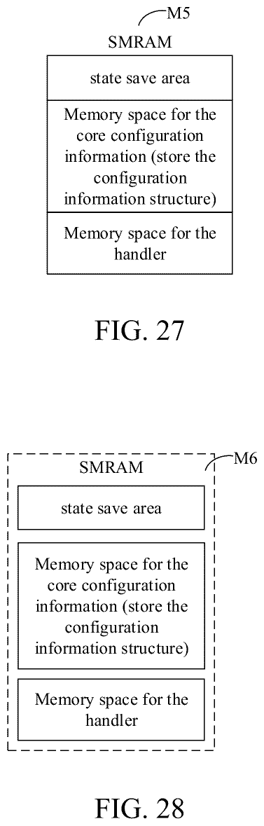

FIG. 27 and FIG. 28 illustrate a schematic diagram of SMRAM in Example 6 according to an embodiment of the present disclosure. The SMRAM of each logical core can be the continuous SMRAM M5 shown in FIG. 27. The SMRAM of each logical core can also be the discontinuous SMRAM M6 shown in FIG. 28. This disclosure does not limit thereto. It is only necessary to ensure that the state save area of each logical core is a continuous memory space, the memory space for the core configuration information of each logical core is also a continuous memory space, and the memory space for the handler is a continuous memory space. The disclosure does not restrict whether the three memory spaces (the state save area, the memory space for the core configuration information and the memory space for the handler in the SMRAM) are continuous. Wherein, in the first memory space composed of the SMRAM of all logical cores in Example 6, each SMRAM may be continuous as in FIG. 21 or discontinuous as in FIG. 20. The disclosure does not limit thereto.

In step S802, the first logical core executes the BIOS to allocate the state save area, the memory space for the core configuration information and the memory space for the handler to each logical core according to the SMRAM of each logical core. The first logical core also stores the address of the state save area of each logical core into the corresponding third MSR 711 of the logical core, stores the address of the memory space for the core configuration information into the corresponding fourth MSR 712, and stores the address of the memory space for a handler into the corresponding fifth MSR 713. Wherein, the first logical core can notify each logical core to store the address of its own state save area into its corresponding third MSR 711, store the address of the memory space for core configuration information into the corresponding fourth MSR 712, and store the address of the memory space for the handler into the corresponding fifth MSR 713 by sending IPI to each logical core.

In step S803, the first logical core executes the BIOS to set the core configuration information of each logical core in the SMM, and stores each core configuration information into the corresponding memory space for the core configuration information in the SMRAM. The core configuration information includes mode-setting information and operating environment information. The first logical core also stores the SMI handler into the corresponding memory space for the handler.

Through the initialization setting provided in Example 6 shown in FIG. 26, the setting for the state save area, the memory space for the core configuration information, and the memory space for the handler of each logical core can be performed in parallel (i.e., each logical core can perform related setting operations in parallel after receiving an IPI). The setting is fast and takes a short time. The rational use of memory space is realized to avoid memory fragmentation and facilitate memory management. Each time each logical core enters the SMM, it does not need to perform the fixed operation of mode switching when executing the SMI handler. This can improve the execution efficiency of the SMI handler. In addition, since the core configuration information can be customized according to actual needs, the setting operations required in the SMI handler can be further reduced. This further improves the execution efficiency of the SMI handler.

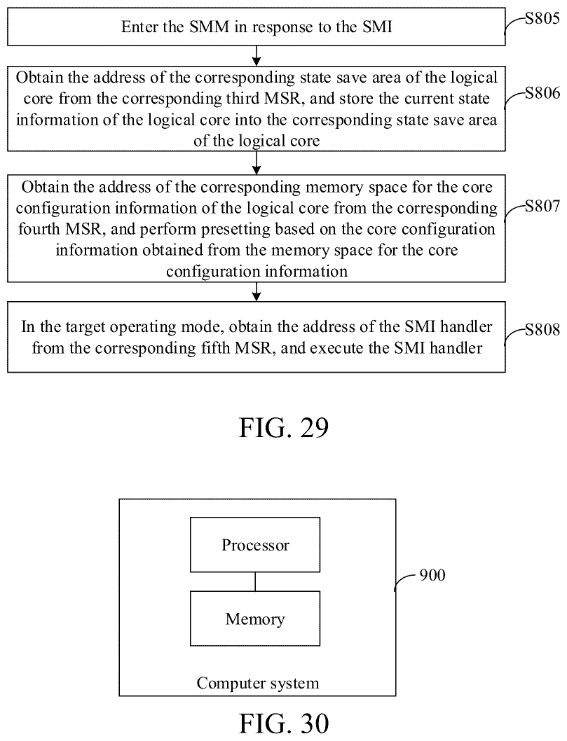

FIG. 29 shows a flowchart of response execution steps in Example 6 according to an embodiment of the present disclosure. As shown in FIG. 29, in this method, the method can also include response execution steps after the completion the initialization setting. The response execution steps can be executed by any logical core in the processor shown in FIG. 25, and can be executed by one or more logical cores simultaneously. As shown in FIG. 29, the response execution steps may include steps S805 to S808. Wherein, steps S805 to S807 are implemented by the hardware of the logical core, and step S808 is implemented by executing the SMI handler by the logical core.

In step S805, the logical core enters the SMM in response to the SMI.

In step S806, the logical core obtains the address of its corresponding state save area from the corresponding third MSR 711, and stores its current state information into the corresponding state save area based on the address of the state save area.

In step S807, the logical core obtains the address of the memory space for the core configuration information where its corresponding core configuration information is located from the corresponding fourth MSR 712, and perform presetting according to the core configuration information obtained from the memory space for the core configuration information. Wherein, the logical core can first obtain the address of the core configuration information structure from the corresponding fourth MSR 712, then obtain the configuration information structure shown in FIG. 10 from the determined address of the core configuration information structure, and then determine each core configuration information based on the core configuration information structure.

In some embodiments, the presetting may include: the logical core performs mode setting according to the corresponding mode-setting information (i.e., set the value of the corresponding register to the setting value indicated in the mode-setting information) to enter the target operating mode; each logical core set the operating environment according to the corresponding operating environment information (i.e., set the value of the corresponding register to the setting value indicated in the operating environment information), and the operating environment setting is completed. The specific setting has been described in the aforementioned paragraph, thus not described.

In some embodiments, the logical core needs to check whether the core configuration information is correct before loading the core configuration information into the register. If there is an error, the computer system can be shut down directly. The logical core loads the core configuration information into the corresponding registers after confirming that the core configuration information is correct.

In step S808, in the target operating mode, the logical core obtains the address of the SMI handler from the fifth MSR 713 and executes the SMI handler. Wherein, the RSM instruction is executed at the end of the SMI handler to exit the SMM.

Through the response execution steps provided in Example 6 shown in FIG. 26, the setting for the state save area, the memory space for the core configuration information and the memory space for the handler of each logical core can be performed in parallel (i.e., each logical core can execute relevant setting operations in parallel after receiving an IPI). The setting is fast and takes a short time. The rational utilization of memory space is realized to avoid memory fragmentation and facilitate memory management. Each time each logical core enters the SMM, it does not need to perform the fixed operation of mode switching when executing the SMI handler. This can improve the execution efficiency of the SMI handler. In addition, since the core configuration information can be customized according to actual needs, the setting operations required in the SMI handler can be further reduced. This further improves the execution efficiency of the SMI handler.

### Example 7

This method is applied in the processor shown in FIG. 17. The method provided in Example 7 is different from the method provided in Example 6 only in the storage of addresses. In Example 7, in the initialization setting, any two of the addresses (specifically, the addresses of the state save area, the memory space for the core configuration information, and the memory space for the handler of each logical core) are stored in the corresponding third MSR, and the remaining address is stored in the corresponding fourth MSR. For example, the address of the state save area and the address of the memory space for the core configuration information of each logical core can be stored in the corresponding third MSR, and the address of the memory space for the handler can be stored in the corresponding fourth MSR. In the response execution step, each logical core obtains the address of its corresponding state save area, the address of the memory space for the core configuration information, and the address of the memory space for the handler from the corresponding MSR. The remaining steps are the same. Accordingly, the benefits of the remaining steps and the related steps can be referred in Example 6 above, thus not repeated here.

FIG. 30 shows a block diagram of a computer system according to an embodiment of the present disclosure. As shown in FIG. 30, the computer system 900 includes a processor and a memory. The processor includes at least one logical core and at least one MSR.

Wherein, the processor is configured to perform an initialization setting before each logical core enters the SMM. The initialization setting includes: allocating SMRAM required in the SMM to each logical core, wherein the corresponding SMRAM of each logical core is located in the memory; and storing the addresses related to the SMRAM of each logical core into the corresponding MSR.

In a possible implementation, the logical core is configured to execute response execution steps after the initialization setting. The response execution steps include: entering the SMM in response to the SMI; storing the current state information of the logical core into the corresponding state save area in the SMRAM; presetting the logical core according to the core configuration information obtained from the corresponding SMRAM; executing the SMI handler; wherein, the address of the state save area and the address of the core configuration information are determined by the addresses stored in the corresponding MSR.

Wherein, the processor shown in FIG. 30 can be the processor shown in FIG. 7, FIG. 12, FIG. 17, and FIG. 25 above. The initialization setting, response execution steps and related benefits can be referred in the above Examples 1 to 7, thus not repeated to avoid redundancy.

It should be noted that although the above embodiments are used as examples to introduce the control method, processor and computer system in the SMM as above, those skilled in the art can understand that the present disclosure should not be limited thereto. In fact, users can flexibly set each step and each device according to personal preferences and/or actual application scenarios, as long as they comply with the technical solution of the present disclosure.

Embodiments of the present disclosure also provide a computer-readable storage medium where program instructions are stored. The above method is implemented when the program instructions are executed by the processor. Computer-readable storage media may be volatile or non-volatile.

An embodiment of the present disclosure also provides an electronic device including: a processor; and memory for storing instructions executable by the processor; wherein the processor is configured to implement the above method when executing instructions stored in the memory.

Embodiments of the present disclosure also provide a computer program product, including computer readable code, or a non-volatile computer readable storage medium storing the computer readable code. When the computer readable code is running in the processor of the electronic device, the processor in the electronic device executes the above method.

The present disclosure may be a system, method, and/or computer program product. A computer program product may include a computer-readable storage medium, which stores computer-readable program instructions for the processor to implement aspects of the present disclosure.

Computer-readable storage media may be physical devices that can keep and store instructions for an instruction execution device. The computer-readable storage medium may be, for example, but not limited to, an electrical storage device, a magnetic storage device, an optical storage device, an electromagnetic storage device, a semiconductor storage device, or any suitable combination of the above. More specific examples (non-exhaustive list) of computer-readable storage media include: portable computer disks, hard disks, random access memory (RAM), read-only memory (ROM), erasable programmable read-only memory (EPROM or Flash memory), static random access memory (SRAM), compact disk read only memory (CD-ROM), digital versatile disk (DVD), memory stick, floppy disk, mechanically encoded device (e.g., hole cards or protruding structures in groove storing instructions), and any suitable combination of the above. The computer-readable storage media herein are not construed as transient signals, such as radio waves or other freely propagating electromagnetic waves, electromagnetic waves propagating through waveguides or other transmission media (e.g., light pulses through fiber optic cables), or electrical signals transmitted through electrical wires.

Computer-readable program instructions described herein may be downloaded from a computer-readable storage medium to various computing/processing devices or to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from the network and forwards the computer-readable program instructions for storage on a computer-readable storage medium in the respective computing/processing device.

Computer program instructions for performing operations of the present disclosure may be assembly instructions, instruction set architecture (ISA) instructions, machine instructions, machine-related instructions, microcode, firmware instructions, state setting data, or source code or object code written in one or any combination of multiple programming languages. The programming language includes object-oriented programming languages (e.g., Smalltalk, C++, etc.), and conventional procedural programming languages, (e.g., the “C” language or similar programming languages). The computer-readable program instructions may execute entirely on the user's computer, partly on the user's computer, as a stand-alone software package, partly on the user's computer and partly on a remote computer, or entirely on the remote computer or server. In case of involving remote computers, the remote computer can be connected to the user's computer through any kind of network, including a local area network (LAN) or a wide area network (WAN), or it can be connected to an external computer (e.g., through the Internet provided by the Internet service provider). In some embodiments, by utilizing state information of computer-readable program instructions to customize an electronic circuit (e.g., a programmable logic circuit, a field programmable gate array (FPGA), or a programmable logic array (PLA)), the electronic circuit can execute computer readable program instructions to implement various aspects of the disclosure.

Aspects of the present disclosure are described herein with reference to flowchart illustrations and/or block diagrams of methods, devices (systems) and computer program products according to embodiments of the disclosure. It should be understood that each block in the flowchart and/or block diagrams, and combinations of blocks in the flowchart and/or block diagrams, can be implemented by computer-readable program instructions.

These computer-readable program instructions may be provided to a processor of a general-purpose computer, a special-purpose computer, or other programmable data processing devices. As a result, a machine/device that realizes the defined functions/actions in the flowchart and/or the block diagram by executing the instructions in the processor of computer, other programmable data processing devices, or other devices is produced. These computer-readable program instructions can also be stored in a computer-readable storage medium. These instructions cause the computer, programmable data processing device and/or other equipment to work in a specific manner. Therefore, the computer-readable medium storing the instructions includes instructions that implement aspects of the functions/acts specified in one or more blocks in the flowcharts and/or block diagrams.

Computer-readable program instructions may also be loaded onto a computer, other programmable data processing devices, or other devices to execute a series of operations that realizes the process of implementing the computer. Accordingly, the defined functions/actions in one or multiple blocks of the flowchart and/or the block diagram are implemented by the instructions executed in computer, other programmable data processing devices, or other devices.

The flowcharts and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions that include one or more executable instructions for implementing the specified logical function(s). In some alternative embodiments, the functions noted in the block may occur out of the order noted in the figures. For example, two consecutive blocks may actually execute substantially in parallel, or they may sometimes execute in the reverse order, depending on the functionality involved. It should also be noted that each block of the block diagram and/or flowchart, and combinations of blocks in the block diagram and/or flowchart, can be implemented by specialized hardware-based systems that perform the specified functions or acts, or by a combination of specialized hardware and computer instructions.

The embodiments of the present disclosure have been described above. The above description is illustrative, not exhaustive, and is not limited to the disclosed embodiments. Many modifications and variations will be apparent to those skilled in the art without departing from the scope and spirit of the described embodiments. The terminology used herein is chosen to best explain the principles, practical applications, or technical improvements in the market of the embodiments, or to enable other persons of ordinary skill in the art to understand the embodiments disclosed herein.

What is claimed is:

1. A control method for a system management mode (SMM), applied to a processor, the processor including at least one logical core, the control method comprising performing an initialization setting before the each logical core enters the SMM, the initialization setting comprising:
allocating system management random access memory (SMRAM) required in the SMM for the each logical core; and
storing address(es) associated with the SMRAM of the each logical core into at least one model specific register (MSR).

2. The method as claimed in claim 1, further comprising response execution steps performed by the logical core after the initialization setting, the response execution steps comprising:
entering the SMM in response to a system management interrupt (SMI);
storing current state information of the logical core into a state save area in a corresponding SMRAM;
presetting the logical core; and
executing an SMI handler;
wherein an address of the state save area is determined by the address stored in a corresponding MSR.

3. The method as claimed in claim 2, wherein the SMRAM comprises:
the state save area, configured to store state information written by a corresponding logical core in response to the SMI; and
a memory space for core configuration information, configured to store the core configuration information, the core configuration information comprising operating environment information, the operating environment information indicating setting values of registers, wherein the values of registers correspond to an operating environment of the logical core in the SMM;
wherein the presetting comprises setting each of the registers corresponding to the operating environment according to the operating environment information.

4. The method as claimed in claim 3, wherein the core configuration information further comprises mode-control information, the mode-control information is configured to indicate a target operating mode that the logical core needs to enter, and the target operating mode comprises a 64-bit mode.

5. The method as claimed in claim 3, wherein the core configuration information further includes at least one of access-control information and interrupt-source-legality information;
the access-control information configured to indicate access authority to target resources, the target resources including at least one of IO port, register, PCI device, and memory space;
the interrupt-source-legality information configured to indicate legality of the SMI.

6. The method as claimed in claim 3, wherein the initialization setting further comprises:
setting the core configuration information of the each logical core in the SMM;
forming a configuration information structure of the each core configuration information according to the core configuration information of the each logical core; and
storing the each configuration information structure respectively into a corresponding memory space for the core configuration information in the SMRAM,
wherein the configuration information structure includes a plurality of information fields, each of which is configured to store corresponding core configuration information or an address of the corresponding core configuration information.

7. The method as claimed in claim 3, wherein the core configuration information further includes mode-setting information, and the mode-setting information indicates a setting value of each corresponding register of a target operating mode;
wherein the presetting includes: setting the each corresponding register of the target operating mode based on the mode-setting information.

8. The method as claimed in claim 7, wherein the at least one logical core includes a first logical core and at least one second logical core;
wherein allocating the SMRAM required in the SMM for the each logical core includes:
applying for a first memory space for the each logical core of the processor, the first memory space being continuous and required in the SMM; and
configuring a start address of the first memory space as a base address of the SMRAM of the first logical core;
wherein the at least one MSR includes a first MSR outside the logical core and is configured to store the base address of the SMRAM of the first logical core;
a base address of the SMRAM of the second logical core is determined by association between the base address corresponding to the first logical core and the base address corresponding to the each second logical core;
in the each SMRAM, a memory space corresponding to a preset address offset of the state save area is the state save area of the corresponding logical core, and a memory space corresponding to a preset address offset of the core configuration information is the memory space for the core configuration information of the corresponding logical core; the base address of the SMRAM is an address of the SMI handler.

9. The method as claimed in claim 8, wherein the response execution steps further comprise:
the first logical core adding the base address obtained from the first MSR and an address offset of the state save area as an address of the state save area of the first logical core, and adding the base address and an address offset of the core configuration information as an address of the memory space for the core configuration information of the first logical core; and/or
the second logical core determining the base address corresponding to the second logical core by the association between the base address obtained from the first MSR and the base address corresponding to the second logical core, adding the base address corresponding to the second logical core and the address offset of the state save area as an address of the state save area of the second logical core, and adding the base address of the second logical core and the address offset of the core configuration information as an address of the core configuration information of the second logical core.

10. The method as claimed in claim 7, wherein the at least one logical core includes a first logical core and at least one second logical core,
wherein allocating the SMRAM required in the SMM for the each logical core includes:
requesting a first memory space for the each logical core of the processor, the first memory space being continuous and required in the SMM;
configuring a start address of the first memory space as a base address of the SMRAM of the first logical core; and
determining a base address of the SMRAM of the each second logical core according to association between the base address corresponding to the first logical core and the base address corresponding to the each second logical core;
wherein the at least one MSR includes a second MSR for each logical core, and the each second MSR is configured to store the base address of the SMRAM of the corresponding logical core;
in the each SMRAM, a memory space corresponding to a preset address offset of the state save area is the state save area of the corresponding logical core, and a memory space corresponding to a preset address offset of the core configuration information is the memory space for the core configuration information of the corresponding logical core; the base address of the SMRAM is an address of the SMI handler.

11. The method as claimed in claim 7, wherein allocating the SMRAM required in the SMM for each logical core comprises:
requesting the SMRAM required in the SMM for the each logical core; and
configuring a start address of the each SMRAM as a base address of the corresponding logical core;
wherein in the each SMRAM, a memory space corresponding to a preset address offset of the state save area is the state save area of the corresponding logical core, and a memory space corresponding a preset address offset of the core configuration information is the memory space for the core configuration information of the corresponding logical core; a base address of the SMRAM is an address of the SMI handler;
the at least one MSR includes a second MSR for each logical core, and the each second MSR is configured to store the base address of the SMRAM of the corresponding logical core.

12. The method as claimed in claim 7, wherein the core configuration information further comprises an address of the SMI handler.

13. The method as claimed in claim 12, wherein allocating the SMRAM required in the SMM for the each logical core comprises:
requesting the SMRAM required in the SMM for the each logical core; and
determining an address of the state save area and an address of the memory space for the core configuration information of the logical core according to an address of the SMRAM of the each logical core;
wherein the at least one MSR includes a third MSR and a fourth MSR for the each logical core, and the each third MSR is configured to store the address of the state save area of the corresponding logical core, and the each fourth MSR is configured to store the address of the memory space for the core configuration information of the corresponding logical core.

14. The method as claimed in claim 12, wherein allocating the SMRAM required in the SMM for the each logical core comprises:
requesting the SMRAM required in the SMM for the each logical core; and
determining an address of the state save area and an address of the memory space for the core configuration information of the logical core according to an address of the SMRAM of the each logical core;
wherein the at least one MSR includes a second MSR for the each logical core, and the each second MSR is configured to store the address of the state save area and the address of the memory space for the core configuration information of the corresponding logical core.

15. The method as claimed in claim 7, wherein the SMRAM further comprises:
a memory space for handler, configured to store the SMI handler.

16. The method as claimed in claim 15, wherein allocating the SMRAM required in the SMM for the each logical core comprises:
requesting the SMRAM required in the SMM for the each logical core; and
space for the core configuration information and an address of the memory space for handler of the logical core according to an address of the SMRAM of the each logical core;
wherein the at least one MSR includes a third MSR, a fourth MSR and a fifth MSR for the each logical core, the each third MSR is configured to store the address of the state save area of the corresponding logical core, the each fourth MSR is configured to store the address of the memory space for the core configuration information of the corresponding logical core, and the each fifth MSR is configured to store the address of the memory space for handler of the corresponding logical core.

17. The method as claimed in claim 15, wherein allocating the SMRAM required in the SMM for the each logical core comprises:
requesting the SMRAM required in the SMM for the each logical core; and
determining an address of the state save area, an address of the memory space for the core configuration information and an address of the memory space for handler of the logical core according to an address of the SMRAM of the each logical core;
wherein the at least one MSR includes a second MSR for the each logical core, and the each second MSR is configured to store the address of the state save area, the address of the memory space for the core configuration information of the corresponding logical core, and the address of the memory space for handler of the corresponding logical core.

18. The method as claimed in claim 15, wherein allocating the SMRAM required in the SMM for the each logical core comprises:
requesting the SMRAM required in the SMM for the each logical core; and
space for the core configuration information and an address of the memory space for handler of the logical core according to an address of the SMRAM of the each logical core;
wherein the at least one MSR includes a third MSR and a fourth MSR for the each logical core, any two of the address of the state save area, the address of the memory space for the core configuration information and the address of the memory space for handler of the each logical core are stored in a corresponding third MSR, and the remaining one is stored in a corresponding fourth MSR.

19. A processor, comprising at least one logical core and at least one model specific register (MSR), and configured to perform an initialization setting before the each logical core enters a system management mode (SMM), the initialization setting comprising:
allocating system management random access memory (SMRAM) required in the SMM for the each logical core; and
storing address(es) associated with the SMRAM of the each logical core into corresponding MSR(s).

20. The processor as claimed in claim 19, wherein the logical core is configured to perform response execution steps after the initialization setting, wherein the response execution steps comprise:
entering the SMM in response to a system management interrupt (SMI);
storing current state information of the logical core into a state save area in a corresponding SMRAM;
presetting the logical core; and
executing an SMI handler;
wherein an address of the state save area is determined by the address stored in the corresponding MSR.

21. The processor as claimed in claim 20, wherein the SMRAM comprises:
the state save area, configured to store state information written by a corresponding logical core in response to the SMI; and
a memory space for core configuration information, configured to store the core configuration information, the core configuration information comprising operating environment information, the operating environment information indicating setting values of registers, wherein the values of registers correspond to an operating environment of the logical core in the SMM;
wherein the presetting comprises setting each of the registers corresponding to the operating environment according to the operating environment information.

22. The processor as claimed in claim 21, wherein the core configuration information further comprises mode-control information, the mode-control information is configured to indicate a target operating mode that the logical core needs to enter, and the target operating mode comprises a 64-bit mode.

23. The processor as claimed in claim 21, wherein the core configuration information further includes at least one of access-control information and interrupt-source-legality information;
wherein the access-control information is configured to indicate access authority to target resources, and the target resources include at least one of IO port, register, PCI device, and memory space;
wherein the interrupt-source-legality information is configured to indicate legality of the SMI.

24. The processor as claimed in claim 21, wherein the initialization setting further comprises:
setting the core configuration information of the each logical core in the SMM;
forming a configuration information structure of the each core configuration information according to the core configuration information of the each logical core; and
storing the each core configuration information structure respectively into a corresponding memory space of the core configuration information in the SMRAM;
wherein the core configuration information structure includes a plurality of information fields, each of which is configured to store corresponding core configuration information or an address of the corresponding core configuration information.

25. The processor as claimed in claim 21, wherein the core configuration information further includes mode-setting information, and the mode-setting information indicates a setting value of each corresponding register of a target operating mode;
wherein the presetting includes: setting the each corresponding register of the target operating mode based on the mode-setting information.

26. The processor as claimed in claim 25, wherein the at least one logical core includes a first logical core and at least one second logical core;
wherein allocating the SMRAM required in SMM for the each logical core includes:
applying for a first memory space for the each logical core of the processor, the first memory space being continuous and required in the SMM; and
configuring a start address of the first memory space as a base address of the SMRAM of the first logical core;
wherein the at least one MSR includes a first MSR outside the logical core and is configured to store the base address of the SMRAM of the first logical core;
a base address of the SMRAM of the second logical core is determined by association between the base address corresponding to the first logical core and the base address corresponding to the each second logical core;
in the each SMRAM, a memory space corresponding to a preset address offset of the state save area is the state save area of the corresponding logical core, and a memory space corresponding to a preset address offset of the core configuration information is the memory space for the core configuration information of the corresponding logical core; the base address of the SMRAM is an address of the SMI handler.

27. The processor as claimed in claim 26, wherein the response execution steps further comprise:
the first logical core obtaining the base address corresponding to the first logical core from the first MSR, adding the base address and an address offset of the state save area as an address of the state save area of the first logical core, and adding the base address and an address offset of the core configuration information as an address of the memory space for the core configuration information of the first logical core; and/or
the second logical core obtaining the base address corresponding to the first logical core from the first MSR, determining the base address corresponding to the second logical core by the association between the base address corresponding to the first logical core and the base address corresponding to the second logical core, adding the base address corresponding to the second logical core and the address offset of the state save area as an address of the state save area of the second logical core, and adding the base address of the second logical core and the address offset of the core configuration information as an address of the core configuration information of the second logical core.

28. The processor as claimed in claim 25, wherein the at least one logical core includes a first logical core and at least one second logical core,
wherein allocating the SMRAM required in SMM for the each logical core includes:
requesting a first memory space for the each logical core of the processor, the first memory space being continuous and required in the SMM;
configuring a start address of the first memory space as a base address of the SMRAM of the first logical core; and
determining a base address of the SMRAM of each second logical core according to association between the base address corresponding to the first logical core and the base address corresponding to the each second logical core;
wherein the at least one MSR includes a second MSR for the each logical core, and the each second MSR is configured to store the base address of the SMRAM of the corresponding logical core;
in the each SMRAM, a memory space corresponding to a preset address offset of the state save area is the state save area of the corresponding logical core, and a memory space corresponding to a preset address offset of the core configuration information is the memory space for the core configuration information of the corresponding logical core; the base address of the SMRAM is an address of the SMI handler.

29. The processor as claimed in claim 25, wherein allocating the SMRAM required in the SMM to the each logical core comprises:
requesting the SMRAM required in the SMM for the each logical core; and
configuring a start address of the each SMRAM as a base address of the corresponding logical core;
wherein in the each SMRAM, a memory space corresponding to a preset address offset of the state save area is the state save area of the corresponding logical core, and a memory space corresponding to a preset address offset of the core configuration information is the memory space for the core configuration information of the corresponding logical core; a base address of the SMRAM is the address of the SMI handler;
the at least one MSR includes a second MSR for the each logical core, and the each second MSR is configured to store the base address of the SMRAM of the corresponding logical core.

30. The processor as claimed in claim 25, wherein the core configuration information further comprises an address of the SMI handler.

31. The processor as claimed in claim 30, wherein allocating the SMRAM required in the SMM for the each logical core comprises:
requesting the SMRAM required in the SMM for the each logical core; and
determining an address of the state save area and an address of the memory space for the core configuration information of the logical core according to the address of the SMRAM of the each logical core;
wherein the at least one MSR includes a third MSR and a fourth MSR for the each logical core, the each third MSR is configured to store the address of the state save area of the corresponding logical core, and the each fourth MSR is configured to store the address of the memory space for the core configuration information of the corresponding logical core.

32. The processor as claimed in claim 30, wherein allocating the SMRAM required in the SMM to the each logical core comprises:
requesting the SMRAM required in the SMM for the each logical core; and
determining an address of the state save area and an address of the memory space for the core configuration information of the logical core according to an address of the SMRAM of the each logical core;
wherein the at least one MSR includes a second MSR for the each logical core, and the each second MSR is configured to store the address of the state save area and the address of the memory space for the core configuration information of the corresponding logical core.

33. The processor as claimed in claim 25, wherein the SMRAM further comprises:
a memory space for a handler, configured to store the SMI handler.

34. The processor as claimed in claim 33, wherein allocating the SMRAM required in the SMM to the each logical core comprises:
requesting the SMRAM required in the SMM for the each logical core; and
determining an address of the state save area, an address of the memory space for the core configuration information and an address of the memory space for handler of the logical core according to the address of the SMRAM of the each logical core;
wherein the at least one MSR includes a third MSR, a fourth MSR and a fifth MSR for the each logical core, the each third MSR is configured to store the address of the state save area of the corresponding logical core, the each fourth MSR is configured to store the address of the memory space for the core configuration information of the corresponding logical core, and the each fifth MSR is configured to store the address of the memory space for handler of the corresponding logical core.

35. The processor as claimed in claim 33, wherein allocating the SMRAM required in the SMM to the each logical core comprises:
requesting the SMRAM required in the SMM for the each logical core; and
space for the core configuration information and an address of the memory space for handler of the logical core via an address of the SMRAM of the each logical core;
wherein the at least one MSR includes a second MSR for the each logical core, and the each second MSR is configured to store the address of the state save area, the address of the memory space for the core configuration information of the corresponding logical core, and the address of the memory space for handler of the corresponding logical core.

36. The processor as claimed in claim 33, wherein allocating the SMRAM required in the SMM to the each logical core comprises:
requesting the SMRAM required in the SMM for the each logical core; and
determining an address of the state save area, an address of the memory space for the core configuration information and an address of the memory space for handler of the logical core according to an address of the SMRAM of the each logical core;
wherein the at least one MSR includes a third MSR and a fourth MSR for the each logical core, any two of the address of the state save area, the address of the memory space for the core configuration information and the address of the memory space for handler of the each logical core are stored in a corresponding third MSR, and the remaining one is stored in a corresponding fourth MSR.

37. A computer system, comprising:
a processor, comprising at least one logical core and at least one model specific register (MSR); and
memory;
wherein the processor is configured to perform an initialization setting before the each logical core enters a system management mode (SMM), and the initialization setting comprises:
allocating system management random access memory (SMRAM) required in the SMM for the each logical core; and
storing address(es) associated with the SMRAM of the each logical core into corresponding MSR(s).

38. The computer system as claimed in claim 37, wherein the logical core is configured to perform response execution steps after the initialization setting, and the response execution steps comprise:
entering the SMM in response to a system management interrupt (SMI);
storing current state information of the logical core into a corresponding state save area in the SMRAM;
presetting the logical core; and
executing an SMI handler;
wherein an address of the state save area is determined by the address stored in the corresponding MSR.
